(19) United States
(12) Patent Application Publication
(10) Pub. No.: US 2024/0357329 A1
(43) Pub. Date: Oct. 24, 2024

(54) COMMUNICATION METHOD AND DEVICE

(71) Applicant: GUANGDONG OPPO MOBILE TELECOMMUNICATIONS CORP., LTD., Dongguan (CN)

(72) Inventors: Ning GAO, Dongguan (CN); Lei HUANG, Singapore (SG)

(21) Appl. No.: 18/758,320

(22) Filed: Jun. 28, 2024

Related U.S. Application Data
(63) Continuation of application No. PCT/CN2022/070871, filed on Jan. 9, 2022.

(51) Int. Cl. H04W 4/38; H04W 24/10

(52) U.S. Cl. CPC H04W 4/38; H04W 24/10

(57) ABSTRACT

A communication method includes: transmitting and/or receiving, by a communication device, a frame carrying sensing measurement reporting dependent information.

### CROSS-REFERENCE TO RELATED APPLICATION

This application is a Bypass Continuation Application of PCT/CN2022/070871 filed Jan. 9, 2022, which is incorporated herein by reference in its entirety.

### TECHNICAL FIELD

The present disclosure relates to the field of communication, and in particular, to a communication method and device.

### BACKGROUND

Wireless local area network (Wireless Local Area Network, WLAN) sensing may refer to a method and an application for sensing people or objects in an environment by measuring a change in a WLAN signal scattered and/or reflected by a person or an object. In the related art, WLAN sensing is generally implemented by using a WLAN signal. How to exchange a message during a reporting phase of the sensing becomes a technical problem that needs to be solved.

### SUMMARY

The embodiments of the present disclosure provide a communication method, including: transmitting and/or receiving, by a communication device, a frame carrying sensing measurement reporting dependent information.

The embodiments of the present disclosure provide a communication device, including a communication unit, configured to transmit and/or receive a frame carrying sensing measurement reporting dependent information.

The embodiments of the present disclosure provide a communication device including a processor and a memory. The memory is configured to store a computer program. The processor is configured to call and run the computer program stored in the memory, so as to enable the communication device to perform the above-mentioned communication method.

The embodiments of the present disclosure provide a chip for implementing the above-mentioned communication method. Specifically, the chip includes a processor, configured to call and run a computer program from a memory, so as to enable a device equipped with the chip to perform the above-mentioned communication method.

The embodiments of the present disclosure provide a non-transitory computer-readable storage medium, configured to store a computer program, where the computer program, upon being executed by a device, causes the device to perform the above-mentioned communication method.

The embodiments of the present disclosure provide a computer program product, including computer program instructions, where the computer program instructions enable a computer to perform the above-mentioned communication method.

The embodiments of the present disclosure provide a computer program, where the computer program, upon being executed by a computer, causes the computer to perform the above-mentioned communication method.

### BRIEF DESCRIPTION OF THE DRAWINGS

FIG. 1 is a schematic diagram of an application scenario according to the embodiments of the present disclosure.

FIG. 2a to FIG. 2j are schematic diagrams of WLAN sensing participants.

FIG. 3 is a schematic diagram of a procedure of a WLAN sensing session.

FIG. 4a is a schematic diagram of sensing measurement parameter negotiation in WLAN sensing.

FIG. 4b and FIG. 4c are schematic diagrams of a threshold based sensing measurement.

FIG. 5 is a schematic diagram of measurement setup and measurement instance.

FIG. 6 is a schematic diagram of a trigger frame based measurement procedure.

FIG. 7a to FIG. 7c are schematic diagrams of a trigger frame based measurement procedure.

FIG. 8 is a schematic flowchart of a communication method according to an embodiment of the present disclosure.

FIG. 9 is a schematic diagram of a sensing measurement reporting trigger frame for triggering uplink EHT TB PPDU transmission according to an embodiment of the present disclosure.

FIG. 10 is a schematic diagram of a sensing measurement reporting frame triggering frame for triggering uplink HE TB PPDU transmission according to an embodiment of the present disclosure.

FIG. 11 is a schematic diagram of a frame structure of a sensing measurement reporting frame based on a common action frame according to an embodiment of the present disclosure.

FIG. 12 is a schematic diagram of a frame structure of a sensing measurement reporting frame based on a newly defined action frame according to an embodiment of the present disclosure.

FIG. 13 is a schematic diagram of a structure of a sensing measurement report element (CSI) according to an embodiment of the present disclosure.

FIG. 14 is a schematic diagram of a structure of a partial bandwidth feedback information field in a sensing measurement report element (CSI) according to an embodiment of the present disclosure.

FIG. 15 is a schematic diagram of a structure of a sensing measurement report element (TCIR) according to an embodiment of the present disclosure.

FIG. 16 is a schematic diagram of a structure of a sensing measurement report element (Extended) according to an embodiment of the present disclosure.

FIG. 17 is a schematic block diagram of a communication device according to the embodiments of the present disclosure.

FIG. 18 is a schematic block diagram of a communication device according to the embodiments of the present disclosure.

FIG. 19 is a schematic block diagram of a chip according to the embodiments of the disclosure.

### DETAILED DESCRIPTION

Technical solutions in the embodiments of the present disclosure will be described below with reference to the accompanying drawings in the embodiments of the present disclosure.

The embodiments of the present disclosure provide a communication method, which includes:
transmitting and/or receiving, by a communication device, a frame carrying sensing measurement reporting dependent information.

In a possible implementation, the frame includes a sensing measurement reporting trigger frame.

In a possible implementation, the sensing measurement reporting dependent information is carried in a field for indicating trigger frame type dependent common information and/or a field for indicating trigger frame type dependent user information.

In a possible implementation, the trigger frame type dependent common information is used to indicate information applied to each user in a user information list.

In a possible implementation, the field carrying the trigger frame type dependent common information includes at least one of:
a field for indicating a sensing trigger frame subtype;
a field for indicating a sensing measurement setup identifier;
a field for indicating a sensing measurement instance identifier; or
a reserved field.

In a possible implementation, a value of the field for indicating the sensing trigger frame subtype being a first value indicates that the frame is the sensing measurement reporting trigger frame.

In a possible implementation, a value of the field for indicating the sensing measurement instance identifier increments by 1 from 0 to 255, and starts for re-incrementation from 0 again after 255 is reached.

In a possible implementation, a length of the field for indicating the trigger frame type dependent common information is a positive integer multiple of 8 bits.

In a possible implementation, the field for indicating the trigger frame type dependent common information is a field in an extremely high throughput (EHT) variant common information field of the sensing measurement reporting trigger frame.

In a possible implementation, the sensing measurement reporting trigger frame is used to trigger uplink EHT trigger frame based (TB) physical layer protocol unit (PPDU) transmission.

In a possible implementation, the field for indicating the trigger frame type dependent user information is a field in an EHT variant user information field of the sensing measurement reporting trigger frame.

In a possible implementation, the trigger frame type dependent user information is used to indicate information applied to a first station (STA), and the first STA is a STA indicated by an identification field in the EHT variant user information field where the field for indicating the trigger frame type dependent user information is located.

In a possible implementation, the field for indicating the trigger frame type dependent user information includes a field for indicating whether to report an aggregation measurement result.

In a possible implementation, a value of the field for indicating whether to report the aggregation measurement result being a second value indicates that the first STA is allowed to report multiple measurement results from different measurement instances simultaneously in a sensing measurement reporting frame triggered by the sensing measurement reporting trigger frame; or, a value of the field for indicating whether to report the aggregation measurement result being a third value indicates that the first STA is not allowed to report multiple measurement results from different measurement instances simultaneously in a sensing measurement reporting frame triggered by the sensing measurement reporting trigger frame.

In a possible implementation, the field for indicating the trigger frame type dependent common information is a field in an HE variant common information field of the sensing measurement reporting trigger frame.

In a possible implementation, the sensing measurement reporting trigger frame is used to trigger uplink high efficiency (HE) TB PPDU transmission.

In a possible implementation, the field for indicating the trigger frame type dependent user information is a field in an HE variant user information field of the sensing measurement reporting trigger frame.

In a possible implementation, the trigger frame type dependent user information is used to indicate information applied to a second STA, and the second STA is a STA indicated by an identification field in the HE variant user information field where the field for indicating the trigger frame type dependent user information is located.

In a possible implementation, the field for indicating the trigger frame type dependent user information includes a field for indicating whether to report an aggregation measurement result.

In a possible implementation, a value of the field for indicating whether to report the aggregation measurement result being a fourth value indicates that the second STA is allowed to report multiple measurement results from different measurement instances simultaneously in a sensing measurement reporting frame triggered by the sensing measurement reporting trigger frame; or, a value of the field for indicating whether to report the aggregation measurement result being a fifth value indicates that the second STA is not allowed to report multiple measurement results from different measurement instances simultaneously in a sensing measurement reporting frame triggered by the sensing measurement reporting trigger frame.

In a possible implementation, the frame includes a sensing measurement reporting frame.

In a possible implementation, the sensing measurement reporting dependent information includes at least one of channel state information (CSI) type of sensing measurement result data, truncated channel impulse response (TCIR) type of sensing measurement result data, or extended type of sensing measurement result data.

In a possible implementation, the CSI type of sensing measurement result data is carried in a CSI type of sensing measurement report element of the sensing measurement reporting frame; or, the TCIR type of sensing measurement result data is carried in a TCIR type of sensing measurement report element of the sensing measurement reporting frame; or, the extended type of sensing measurement result data is carried in an extended type of sensing measurement report element of the sensing measurement reporting frame.

In a possible implementation, the CSI type of sensing measurement report element or the TCIR type of sensing measurement report element includes at least one of.
a field for indicating an element identifier;
a field for indicating a length;
a field for indicating element identifier extension;
a field for indicating a sensing measurement setup identifier;
a field for indicating a sensing measurement instance identifier;
a field for indicating a sensing measurement timestamp;
a field for indicating sensing measurement result control; or
a field for indicating sensing measurement result data.

In a possible implementation, a value of the field for indicating the element identifier extension being a sixth value indicates the CSI type of sensing measurement report element; or
a value of the field for indicating the element identifier extension being a seventh value indicates the TCIR type of sensing measurement report element.

In a possible implementation, the field for indicating the sensing measurement result control in the CSI type of sensing measurement report element includes at least one of:
a field for indicating a number of columns of a CSI matrix;
a field for indicating a number of rows of a CSI matrix;
a field for indicating a channel bandwidth;
a field for indicating partial bandwidth information;
a field for indicating a coding mode of CSI data for reporting;
a field indicating a number of coding bits;
a field for indicating a grouping factor;
a field for indicating a measurement frame (NDP) type; or
a reserved field.

In a possible implementation, the field for indicating the sensing measurement result control in the TCIR type of sensing measurement report element includes at least one of:
a field for indicating a number of columns of a TCIR matrix;
a field for indicating a number of rows of a TCIR matrix;
a field for indicating a channel bandwidth;
a field for indicating a TCIR type;
a field for indicating a coding mode of TCIR data for reporting;
a field indicating a number of coding bits;
a field for indicating a length of a TCIR segment;
a field for indicating a number of TCIR segments;
a field for indicating a TCIR segment list;
a field for indicating an NDP type; or
a reserved field.

In a possible implementation, the extended type of sensing measurement report element includes at least one of.
a field for indicating an element identifier;
a field for indicating a length;
a field for indicating element identifier extension;
a field for indicating a sensing measurement setup identifier;
a field for indicating a sensing measurement instance identifier;
a field for indicating an NDP type;
a field for indicating HE-SIG-A/U-SIG information; or
a field for indicating a carrier frequency offset (CFO).

In a possible implementation, a value of the field for indicating the element identifier extension being an eighth value indicates the extended type of sensing measurement report element.

In a possible implementation, at least one of the CSI type of sensing measurement report element, the TCIR type of sensing measurement report element, and the extended-type of sensing measurement report element is carried in a field of the sensing measurement reporting frame for indicating a sensing measurement report list; and the field for indicating the sensing measurement report list is carried in a field of the sensing measurement reporting frame for indicating an action domain.

In a possible implementation, the field for indicating the action domain further includes at least one of.
a field for indicating an action type;
a field for indicating a common action subtype; or
a field for indicating a sensing subtype.

In a possible implementation, a value of the field for indicating the action type being an eighth value indicates that the sensing measurement reporting frame belongs to a common action frame; or,
a value of the field for indicating the common action subtype being a ninth value indicates that the sensing measurement reporting frame belongs to a sensing action frame; or,
a value of the field for indicating the sensing subtype being a tenth value indicates a sensing measurement reporting frame.

In a possible implementation, the field for indicating the action domain further includes at least one of:
a field for indicating an action type; or
a field for indicating a sensing action subtype.

In a possible implementation, a value of the field for indicating the action type being an eleventh value indicates that the sensing measurement reporting frame belongs to a newly defined sensing action frame; or,
a value of the field for indicating the sensing action subtype being a twelfth value indicates a sensing measurement reporting frame.

In a possible implementation, a coding mode of CSI data or a coding mode of TCIR data includes at least one of low-complexity direct coding, low-complexity differential coding, or phase coding.

In a possible implementation, the low-complexity direct coding includes at least one of following steps:
calculating a scaling factor;
linearly scaling a real part and an imaginary part of an element in a matrix according to the scaling factor, and quantizing scaled real part and imaginary part into multiple intervals; or
performing direct coding on quantized data.

In a possible implementation, the low-complexity differential coding includes at least one of following steps:
calculating a scaling factor;
linearly scaling a real part and an imaginary part of an element in a matrix according to the scaling factor, and quantizing scaled real part and imaginary part into multiple intervals; or
performing differential coding on quantized data.

The technical solutions in the embodiments of the present disclosure can be applied to various communication systems, such as wireless local area networks (Wireless Local Area Networks, WLAN), wireless fidelity (Wireless Fidelity, WiFi) or other communication systems.

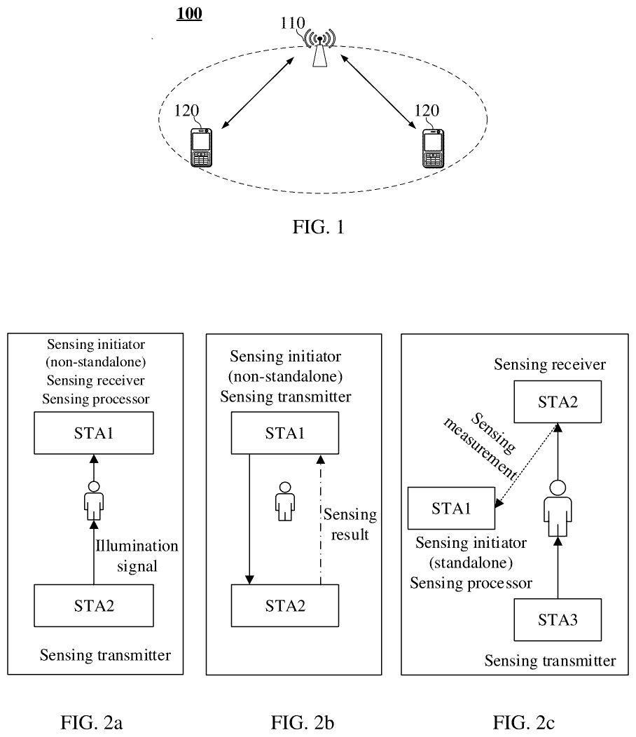

For example, a communication system 100 applied in the embodiments of the present disclosure is shown in FIG. 1. The communication system 100 may include an access point (Access Point, AP) 110, and a station (STATION, STA) 120 that accesses the network through the access point 110.

In some scenarios, the AP is also called an AP STA. That is, in a certain sense, the AP is also a kind of STA.

In some scenarios, STA is also called a non-AP STA (non-AP STA).

Communication in the communication system 100 may be a communication between an AP and a non-AP STA, may also be a communication between a non-AP STA and a non-AP STA, or a communication between a STA and a peer STA, where the peer STA may refer to a device that performs peer-to-peer communication with the STA. For example, the peer STA may be an AP or a non-AP STA.

The AP is equivalent to a bridge for connecting a wired network and a wireless network. The main function of the AP is to connect various wireless network clients together, and then connect the wireless network to the Ethernet. The AP device may be a terminal device (such as a mobile phone) or a network device (such as a router). The terminal device or the network device is equipped with a chip for implementing a communication function, such as a WLAN chip, or a WiFi chip.

It should be understood that the role of the STA in the communication system is not absolute. For example, in some scenarios, when a mobile phone is connected to a router, the mobile phone is a non-AP STA. When the mobile phone is used as a hotspot for other mobile phones, the mobile phone acts as an AP.

The AP and the non-AP STA may be: devices used in the Internet of Vehicles; Internet of Things (Internet Of Things, IoT) nodes, sensors, and the like in the IoT; smart cameras, smart remote controls, smart water and electricity meters and the like in the smart home; and sensors in the smart city.

In some embodiments, the non-AP STA may support 802.11be standard. The non-AP STA may also support multiple current and future 802.11 family wireless local area networks (wireless local area networks, WLAN) standards, such as 802.11ax, 802.11ac, 802.11n, 802.11g, 802.11b, and 802.11a.

In some embodiments, the AP may be a device supporting 802.11be standard. The AP may also be a device that supports various current and future 802.11 family WLAN standards, such as 802.11ax, 802.11ac, 802.11n, 802.11g, 802.11b, and 802.11a.

In the embodiments of the present disclosure, the STA may be a mobile phone (Mobile Phone), a pad (Pad), a computer, a virtual reality (Virtual Reality, VR) device, and an augmented reality (Augmented Reality, AR) device that supports WLAN/WiFi technology, a wireless device in the industrial control, a set-top box, a wireless device in the self-driving (self driving), a vehicle-mounted communication device, a wireless device in the remote medical (remote medical), a wireless device in the smart grid (smart grid), a wireless device in the transportation safety (transportation safety), a wireless device in the smart city (smart city) or a wireless device in the smart home (smart home), a wireless communication chip/ASIC/SOC, etc.

Frequency bands that the WLAN technology can support may include but not be limited to: low frequency bands (such as 2.4 GHz, 5 GHz, 6 GHz) and high frequency bands (such as 60 GHz).

FIG. 1 exemplarily shows one AP STA and two non-AP STAs. Optionally, the communication system 100 may include multiple AP STAs and other quantities of non-AP STAs, which is not limited in the embodiments of the present disclosure.

It should be understood that the terms “system” and “network” are often used interchangeably herein. The term “and/or” herein is only an association relationship to describe associated objects, which indicates that there may be three kinds of relationships, for example, A and/or B may indicate three cases where: A exists alone, both A and B exist, and B exists alone. In addition, a character “/” herein generally indicates that related objects before and after “/” are in an “or” relationship.

It should be understood that “indication” involved in embodiments of the present disclosure may be a direct indication, may be an indirect indication, or may represent an association relationship. For example, A indicating B may mean that A indicates B directly, for example, B can be acquired through A; or A indicating B may mean that A indicates B indirectly, for example, A indicates C, and B can be acquired through C; or A indicating B may mean that there is an association between A and B.

In the description of the embodiments of the present disclosure, the term “correspond” may mean that there is a directly corresponding relationship or an indirectly corresponding relationship between two parties, or mean that there is an association between two parties, or mean a relationship such as indicating and being indicated, or configuring and being configured.

In order to facilitate understanding of the technical solutions of the embodiments of the present disclosure, related technologies involved in the embodiments of the present disclosure will be described in the following. The following relevant technologies, as optional solutions, can be arbitrarily combined with the technical solutions of the embodiments of the present disclosure, and these combined solutions all fall within the protection scope of the embodiments of the present disclosure.

### I. WLAN Sensing and Participants

A WLAN terminal participating in the sensing may have a role such as a sensing session initiator (may also be called a sensing initiator), a sensing session responder (may also be called a sensing responder), a sensing signal transmitter (may also be called a sensing transmitter), or a sensing signal receiver (may also be called a sensing receiver).

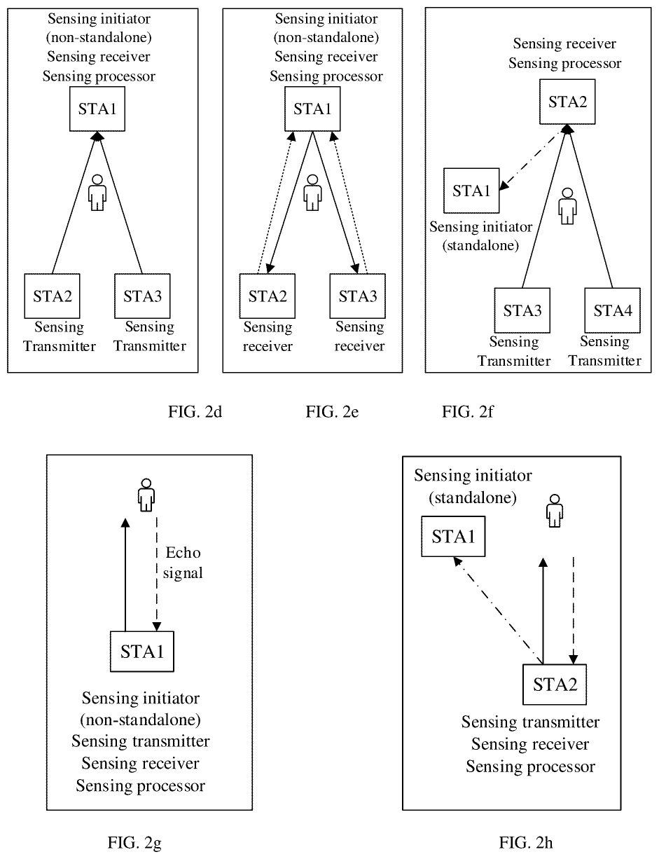

FIG. 2a to FIG. 2j show schematic diagrams of several WLAN sensing and participants. For example, referring to FIG. 2a, STA1 is a sensing initiator (non-standalone (non-standalone)), a sensing receiver, and a sensing processor (Sensing processor), and STA2 is a sensing transmitter. Referring to FIG. 2b, STA1 is a sensing initiator (non-standalone) and a sensing transmitter, and STA2 is a sensing receiver and a sensing processor. Referring to FIG. 2c, STA1 is a sensing initiator (standalone) and a sensing processor, STA2 is a sensing receiver, and STA3 is a sensing transmitter. Referring to FIG. 2d, STA1 is a sensing initiator (non-standalone), a sensing receiver, and a sensing processor, and STA2 and STA3 are sensing transmitters. Referring to FIG. 2e, STA1 is a sensing initiator (non-standalone), a sensing transmitter, and a sensing processor, and STA2 and STA3 are sensing receivers. Referring to FIG. 2f, STA1 is a sensing initiator (standalone), STA2 is a sensing receiver and a sensing processor, and STA3 and STA4 are sensing transmitters. Referring to FIG. 2g, STA1 is a sensing initiator (non-standalone), a sensing transmitter, a sensing receiver, and a sensing processor. Referring to FIG. 2h, STA1 is a sensing initiator (standalone), and STA2 is a sensing transmitter, a sensing receiver, and a sensing processor. Referring to FIG. 2i, STA1 is a sensing initiator (non-standalone), a sensing transmitter, a sensing receiver, and a sensing processor, and STA2 is a sensing transmitter and a sensing receiver. Referring to FIG. 2j, STA1 is a sensing initiator (standalone) and a sensing processor, STA2 is a sensing transmitter and a sensing receiver, and STA3 is also a sensing transmitter and a sensing receiver. In FIG. 2a to FIG. 2j, a solid arrow represents an illumination signal (illumination signal), a short-interval dashed arrow represents a sensing measurement (sensing measurement), a dot-dash arrow represents a sensing result (sensing result), and a long-interval dashed arrow represents an echo signal (echo signal). The illumination signal (illumination signal) may also be a sensing measurement signal (sensing measurement). The illumination signal is attenuated and diffracted upon being blocked by a person, and the characteristics of the illumination signal are changed upon being received by a sensing receiving device. An echo signal (echo signal) is generated when the illumination signal is reflected by a person, and the sensing receiving device receives the echo signal to sense the changes.

It should be noted that a STA only represents the role of the STA, and does not used to limit the number of STAs in FIG. 2a to FIG. 2j and the following steps such as sensing session, and sensing measurement. For example, the number of the STA(s) serving as the role represented by STA1, STA2, or STA3 is one or more.

### II. Overall Procedure of WLAN Sensing Session

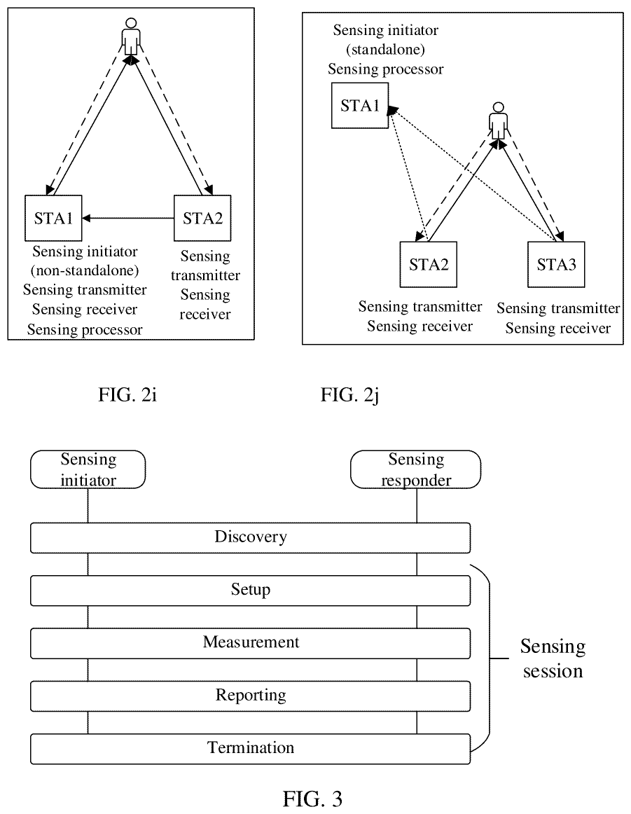

Referring to FIG. 3, a WLAN sensing session includes one or more of the following phases: a session setup (Session Setup), a sensing measurement setup establishment (Measurement Setup), a sensing measurement (Measurement), a sensing reporting (Reporting), a sensing measurement setup termination (Measurement Setup Termination), or a session termination (Session Termination). A WLAN terminal may serve as one or more roles during a sensing session. For example, a sensing session initiator may be only the sensing session initiator, or may also be a sensing signal transmitter or a sensing signal receiver, or both a sensing signal transmitter and a sensing signal receiver.

Session setup phase: a sensing session is set up, and common sensing parameters and a sensing capability of a device are determined.

Sensing measurement setup establishment phase: sensing session participants and roles thereof (including a sensing signal transmitter and a sensing signal receiver) are determined, operating parameters related to a sensing measurement are determined, and the parameters are optionally exchanged between terminals.

Sensing measurement phase: a sensing measurement is implemented, and the sensing signal transmitter sends a sensing signal to the sensing signal receiver.

Sensing reporting phase: a measurement result is reported, and depending on an application scenario, the sensing signal receiver may need to report the measurement result to the sensing session initiator.

Sensing measurement setup termination phase: a terminal terminates a measurement corresponding to a measurement setup and clears a related resource.

Session termination phase: a terminal stops measurement and terminates a sensing session.

### III. WLAN Sensing Measurement Setup Parameter Negotiation

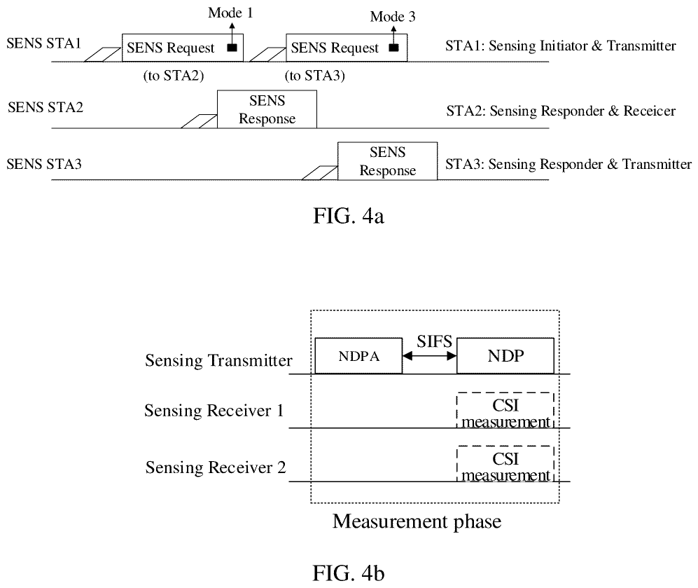

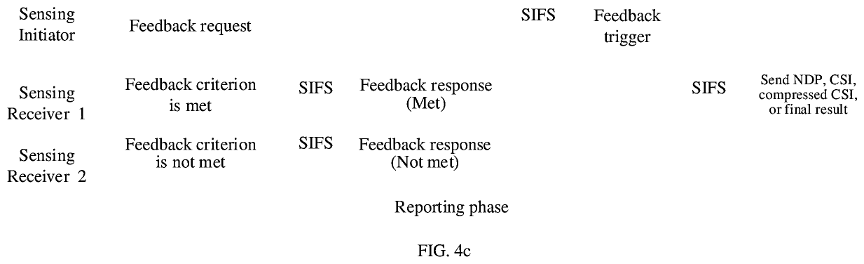

During the sensing measurement setup establishment, sensing roles and operating parameters may need to be negotiated one by one between terminals, or the terminals declare their own roles and operating parameters (e.g., through a beacon frame or other special frames). For example, referring to FIG. 4a, SENS STA1 may be a sensing initiator and transmitter (Sensing Initiator and Transmitter). SENS STA2 may be a sensing responder and receiver (Sensing Responder and Receiver). SENS STA3 may be a sensing responder and transmitter (Sensing Responder and Transmitter). Mode 1: the terminal SENS STA1 transmits a sensing request (SENS Request) to SENS STA2, and SENS STA2 transmits a sensing response (SENS Response). Mode 3: the terminal SENS STA1 transmits a sensing request (SENS Request) to SENS STA3, and SENS STA3 transmits a sensing response (SENS Response).

The data volume of a sensing measurement result is usually large. For example, the channel state information (Channel State Information, CSI) data obtained in one measurement may reach 4K to 40K bits (Bit). In order to reduce the network load caused by reporting the sensing measurement result, a measurement threshold may be set. When a change between the current measurement result and the previous measurement result is less than the threshold, the sensing signal receiver reports the sensing result, otherwise the sensing result is not reported.

For example, as shown in FIG. 4b, in the measurement phase (Measurement phase), a sensing transmitter (Sending Transmitter) may transmit a measurement announcement (NDP Announcement, NDPA) frame, and, after a short interframe space (Short Interframe Space, SIFS), transmit a null data packet (Null Data Packet, NDP). Sensing receiver 1 (Sending Receiver1) and sensing receiver 2 (Sending Receiver2) may perform CSI measurements (Measurement). As shown in FIG. 4c, in the reporting phase (Reporting phase), the sensing initiator (Sensing Initiator) transmits a feedback request (Feedback request). When sensing receiver 1 (Sending Receiver1) determines that a feedback criterion is met (Feedback criterion is met), a feedback response (Feedback response) indicating that the feedback criterion is met (Met) is sent. When sensing receiver 2 (Sending Receiver2) determines that a feedback criterion is not met (Feedback criterion is not met), a feedback response (Feedback response) indicating that the feedback criterion is not met (Met) is sent. Subsequently, the sensing initiator transmits a feedback trigger (Feedback Trigger), and the sensing receiver 1 transmits an NDP, CSI, compressed (compressed) CSI or a final result.

### IV. Measurement Setup and Measurement Instance

A sensing session initiator may set an establishment (measurement setup) procedure to establish multiple sets of measurement parameters. A set of measurement parameters may be identified by a measurement setup identifier (Measurement Setup ID) and may be applied to multiple measurements (the multiple measurements may be equivalent to a burst group (Burst Group)). Each measurement of another set of measurement parameters (which may be equivalent to a burst (Burst)) may be identified by a measurement instance ID (Measurement Instance ID), which may be equivalent to a burst (Burst).

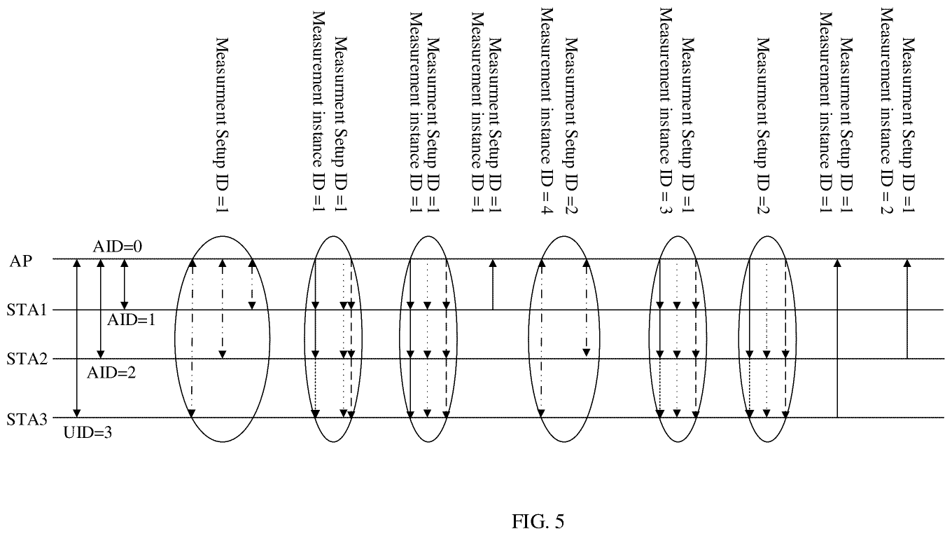

For example, referring to FIG. 5, an association identifier (Association Identifier, AID) of AP is 0, an AID of STA1 is 1, an AID of STA2 is 2, and an unassociation identifier (Unassociation Identifier, UID) of STA3 is 3. AP may establish measurement setup with STA1, STA2 and STA3 at different time points, and the measurement setup identifier (Measurement Setup ID) is 1. AP may simultaneously transmit a sensing measurement polling frame, a sensing announcement frame, and a sensing measurement frame to STA1, STA2, and STA3, the measurement setup ID is 1, and the measurement instance ID is 1. AP may simultaneously transmit a sensing measurement polling frame, a sensing announcement frame, and a sensing measurement frame to STA1, STA2, and STA3, the measurement setup ID is 2, and the measurement instance ID is 1. STA1 may transmit a sensing measurement reporting frame to AP to report a sensing measurement result obtained under a condition that the measurement setup ID is 1 and the measurement instance ID is 1.

AP may establish measurement setup with STA2 and STA3 at different time points, and the measurement setup ID is 2. AP may simultaneously transmit a sensing measurement polling frame, a sensing announcement frame, and a sensing measurement frame to STA1, STA2, and STA3, the measurement setup ID is 3, and the measurement instance ID is 1. AP may simultaneously transmit a sensing measurement polling frame a sensing announcement frame, and a sensing measurement frame to STA2 and STA3, the measurement setup ID is 2, and the measurement instance ID is 4. STA3 may transmit a sensing measurement reporting frame to AP to report a sensing measurement result obtained under a condition that the measurement setup ID is 1 and the measurement instance ID is 1. STA2 may transmit a sensing measurement reporting frame to AP to report a sensing measurement result obtained under a condition that the measurement setup ID is 1 and the measurement instance ID is 1.

### V. Trigger Frame Based Measurement Procedure

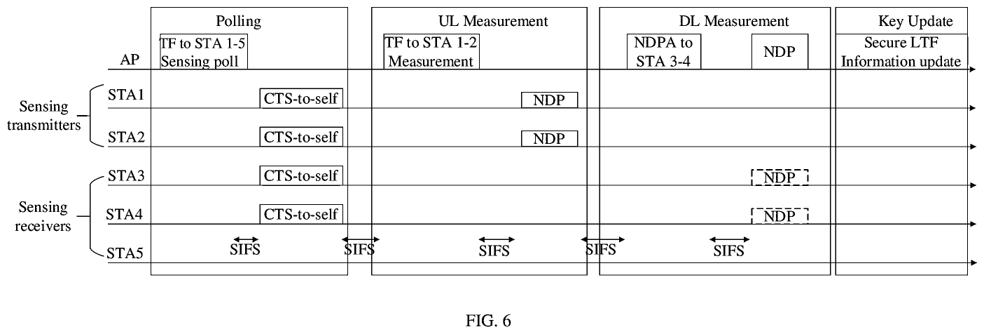

A trigger frame based measurement procedure includes phrases such as polling (Polling), uplink measurement (UL (Uplink) sensing sounding), downlink measurement (DL (Downlink) sensing sounding) and key update (Key update). As shown in FIG. 6, STA1 and STA2 are sensing transmitters (Sensing Transmitter), and STA3, STA4, and STA5 are sensing receivers (Sensing Receiver).

Polling should always be here to check the availability of responder STAs before performing the actual sensing measurement (Polling should always be here to check the availability of responder STAs before performing the actual sensing measurement).

In response to the polling frame, STA1 to STA4 each transmits a CTS-to-self (Clear To Send to self, CTS-to-self) frame to confirm STA1 to STA4 will participate in upcoming measurement (Here STA1-4 respond with CTS-to-self to confirm they will participate in upcoming sensing sounding).

STA 5 does not send a CTS-to-self frame back, so AP will not include STA 5 in upcoming measurement (STA5 does not send CTS-to-self back, so AP will not include STA5 in upcoming sensing sounding).

Optionally, UL measurement is present, conditioned on at least one sensing transmitter responds in the polling (UL sensing sounding is optionally present, conditioned on at least one sensing transmitter responds in the polling).

AP sends a trigger frame (Trigger Frame, TF) to STA1 and STA2 to solicit NDP packet transmission to do UL measurement (AP sends a TF to STA1-2 to solicit NDP packet transmission to do UL sensing sounding).

NDPs from STA1 and STA2 could be transmitted simultaneously in the uplink multiple-input multiple-output (Uplink Multiple-Input Multiple-Output, UL-MIMO) or uplink orthogonal frequency division multiple access (Uplink Orthogonal Frequency Division Multiple Access, UL-OFDMA) (NDP from STA1-2 could be transmitted simultaneously in UL-MIMO/UL-OFDMA).

Optionally, DL measurement is present, conditioned on at least one sensing receiver responds in the polling (DL sensing sounding is optionally present, conditioned on at least one sensing transmitter receiver in the polling).

AP transmits NDPA+NDP to STA3 and STA4 to perform DL measurement (AP sends NDPA+NDP to STA3-4 to perform DL sensing sounding).

Key update is optionally present if secure LTF information needs to be updated and communicated to STAs (Key update is optionally present if secure LTF info needs to be updated and communicated to STAs).

The updated information can be carried in an action or management frame (The updated information can be carried in an action or management frame).

### VI. Trigger Frame Based Measurement Procedure

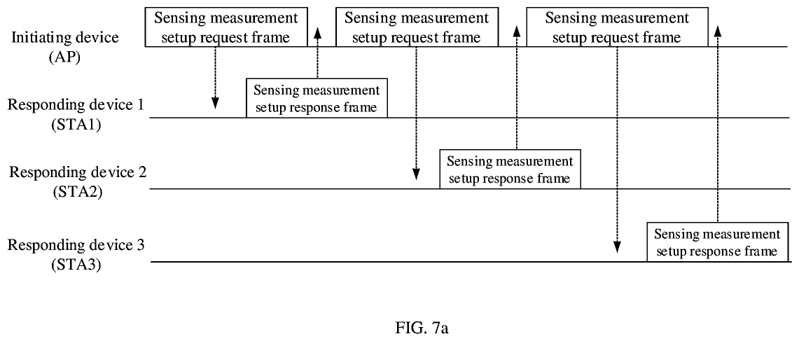

A trigger frame based measurement procedure includes three phases: a sensing measurement setup phase, a sensing measurement phase and a sensing reporting phase, which are shown in FIG. 7a, FIG. 7b and FIG. 7c, respectively.

As shown in FIG. 7a, a procedure of a trigger frame based sensing measurement setup phase may include the following processes: an initiating device (such as an AP) may transmit sensing measurement setup request frames to multiple responding devices (for example, responding devices 1, 2, and 3 are STA1, STA12, and STA3, respectively). STA1, STA12, and STA3 transmit sensing measurement setup response frames to the AP in different time periods.

As shown in FIG. 7b, a procedure of a trigger frame based sensing measurement phase may include the following processes: in a measurement polling process, an initiating device (such as an AP) may simultaneously transmit sensing measurement polling trigger frames to multiple responding devices (such as responding devices 1, 2 and 3, which are STA1, STA12 and STA3, respectively). STA1, STA12, and STA3 transmit CTS-to-self (CTS-to-self) frames to the AP in the same time period. In an uplink measurement process, an initiating device (such as an AP) transmits sensing measurement trigger frames to responding devices 1, 2 and 3 in the same time period, respectively, and receives feedback measurement frames (such as NDPs) from the responding devices. In a downlink measurement process, an initiating device (such as an AP) transmits sensing measurement announcement frames to responding devices 1, 2, and 3 in the same time period, respectively, and the initiating device (such as the AP) transmits measurement frames to the responding devices 1, 2 and 3 in the same time period, respectively. The CTS-to-self frame is a frame format defined in relevant standards and is used to respond to the sensing polling trigger frame here.

As shown in FIG. 7c, a procedure of a trigger frame based sensing reporting phase may include the following processes: in a reporting preparation process, an initiating device (such as an AP) may transmit sensing feedback request frames to multiple responding devices (such as responding devices 1, 2 and 3, which are STA1, STA2 and STA3, respectively). STA1, STA2 and STA3 transmit sensing feedback response frames to the AP in the same time period, respectively. In a reporting process, an initiating device (such as an AP) transmits sensing measurement reporting trigger frames to responding devices 1 and 2 in the first time period, respectively, and the responding devices 1 and 2 feed back sensing measurement reporting frames to the initiating device in the same time period. The initiating device (such as an AP) transmits a sensing measurement reporting trigger frame to the responding device 3 in the second time period, and the responding device 3 feeds back a sensing measurement reporting frame to the initiating device.

With respect to the above-mentioned trigger frame based sensing measurement method or a non-trigger frame based sensing measurement method, the embodiments of the present disclosure may provide a specific frame format for information exchange in a sensing reporting phase.

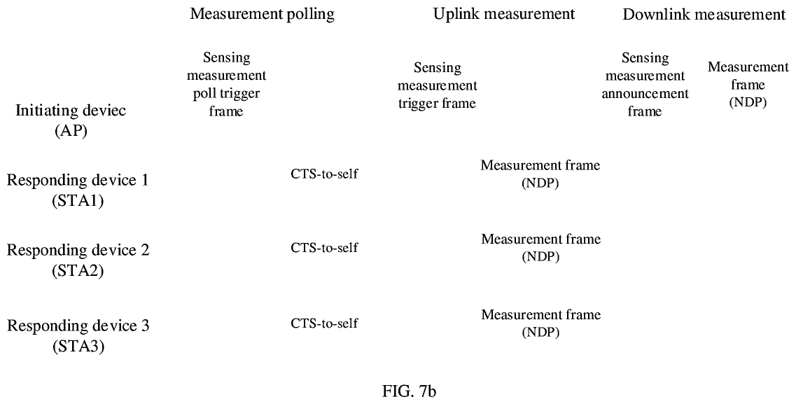

FIG. 8 is a schematic flowchart of a communication method 800 according to an embodiment of the present disclosure. Optionally, the method may be applied to the system shown in FIG. 1, but is not limited thereto. The method includes at least part of the following contents. [0125] 5810: transmitting and/or receiving, by a communication device, a frame carrying sensing measurement reporting dependent information.

In a possible implementation, a frame carrying the sensing measurement reporting dependent information may be a sensing measurement reporting triggering frame.

In a possible implementation, the communication device may be a first device. The first device may transmit a frame carrying sensing measurement reporting dependent information. For example, the first device may transmit a sensing measurement reporting trigger frame carrying sensing measurement reporting dependent information to the second device. The first device may include an access point station (may be referred to as an AP).

Alternatively, in a possible implementation, the communication device may be the second device. The second device may receive a frame carrying sensing measurement reporting dependent information. For example, the second device may receive a sensing measurement reporting trigger frame carrying sensing measurement reporting dependent information from the first device. The second device may include a non-access point station (may be referred to as a STA), and the first device may include an access point station (may be referred to as an AP).

In a possible implementation, the sensing measurement reporting dependent information may be carried in a field for indicating trigger frame type dependent common information and/or a field for indicating trigger frame type dependent user information. For example, the field for indicating the trigger frame type dependent common information may be expressed as trigger frame type dependent common information (Trigger Dependent Common Info), which is used to indicate information applied to each user in the user information list.

In a possible implementation, a length of the field for indicating the trigger frame type dependent common information is a positive integer multiple of 8 bits, such as 8, 16, 24, or 32 bits.

In a possible implementation, the field for indicating the trigger frame type dependent common information includes a field for indicating a sensing trigger frame subtype. For example, the field for indicating the sensing trigger frame subtype may be expressed as a sensing trigger frame subtype (Sensing Subtype).

In a possible implementation, the field for indicating the trigger frame type dependent common information further includes at least one of the following:
a field for indicating a sensing measurement setup identifier (ID);
a field for indicating a sensing measurement instance identifier (ID); or
a reserved field.

In a possible implementation, a value of the field for indicating the sensing measurement instance identifier (ID) increments by 1 from 0 to 255, and starts for re-incrementation from 0 again after 255 is reached.

In a possible implementation, a value of the field for indicating the sensing trigger frame subtype being a first value indicates that the trigger frame carrying the sensing measurement reporting dependent information is a sensing measurement reporting trigger frame. For example, the value of the field for indicating the sensing trigger frame subtype being 2 indicates that the frame is a sensing measurement reporting trigger frame (Sensing Feedback Trigger Frame). The value of this field being 2 is only an example, and any value from 0 to 15 or other values may also be used to indicate that the frame is a sensing measurement reporting trigger frame.

In the embodiments of the present disclosure, the sensing measurement reporting trigger frame can be used in the trigger frame based sensing reporting phase. The first device (e.g., AP) transmits a sensing measurement reporting trigger frame to the second device (e.g., STA). The second device (e.g., STA) performs sensing measurement and feeds back the sensing measurement result to the first device (e.g., AP) through the sensing measurement reporting frame.

In a possible implementation, the sensing measurement reporting trigger frame may be used to trigger a transmission of an extremely high throughput (Extremely High Throughput, EHT) trigger frame based (Trigger Based, TB) physical layer protocol unit (Physical Protocol Data Unit, PPDU) carrying the sensing measurement reporting frame in the uplink or a transmission of a high efficiency (High Efficiency, HE) TB PPDU carrying the sensing measurement reporting frame in the uplink. When the sensing measurement reporting trigger frame is used to trigger the transmission of the uplink EHT TB PPDU, the 54th and 55th bits of the common information field of the frame (such as the EHT variant common information field) can be set to 0; when the sensing measurement reporting trigger frame is used to trigger the transmission of the uplink HE TB PPDU, the 54th and 55th bits of the common information field of the frame (such as the HE variant common information field) can be set to 1.

In a possible implementation, the sensing measurement reporting trigger frame is used to trigger uplink EHT trigger frame based (TB) physical layer protocol unit (PPDU) transmission, where the field for indicating the trigger frame type dependent common information may be a field in the EHT variant common information field of the sensing measurement reporting trigger frame.

In a possible implementation, the trigger frame type dependent user information is used to indicate information applied to a first station (STA), where the first STA is a STA indicated by an identification field in the EHT variant user information field where the field for indicating the trigger frame type dependent user information is located.

In a possible implementation, the field for indicating the trigger frame type dependent user information includes a field for indicating whether to report an aggregation measurement result.

For example, a value of the field for indicating whether to report the aggregation measurement result being a second value indicates that the first STA is allowed to report multiple measurement results from different measurement instances simultaneously in a sensing measurement reporting frame triggered by the sensing measurement reporting trigger frame; or,
a value of the field for indicating whether to report the aggregation measurement result being a third value indicates that the first STA is not allowed to report multiple measurement results from different measurement instances simultaneously in a sensing measurement reporting frame triggered by the sensing measurement reporting trigger frame.

For example, when the value of the field for indicating whether to report the aggregation measurement result is 1, it indicates that aggregation reporting is permitted (i.e., the first STA is allowed to simultaneously report multiple measurement results from different measurement instances in a sensing measurement reporting frame triggered by the sensing measurement reporting trigger frame), and when the value is 0, it indicates that aggregation reporting is not possible (i.e., the first STA is not allowed to simultaneously report multiple measurement results from different measurement instances in a sensing measurement reporting frame triggered by the sensing measurement reporting trigger frame). The above values are only examples, and the embodiments of the present disclosure may also use other values to indicate whether aggregation reporting is permitted.

In a possible implementation, the sensing measurement reporting trigger frame is used to trigger uplink high-efficiency HE TB PPDU transmission, and the field for indicating trigger frame type dependent common information may be a field in the HE variant common information field of the sensing measurement reporting trigger frame.

In a possible implementation, the trigger frame type dependent user information is used to indicate information applied to a second STA, and the second STA is a STA indicated by an identification field in the HE variant user information field where the field for indicating the trigger frame type dependent user information is located.

In a possible implementation, the field for indicating the trigger frame type dependent user information includes a field for indicating whether to report an aggregation measurement result.

For example, a value of the field for indicating whether to report the aggregation measurement result being a fourth value indicates that the second STA is allowed to report multiple measurement results from different measurement instances simultaneously in a sensing measurement reporting frame triggered by the sensing measurement reporting trigger frame; or,
a value of the field for indicating whether to report the aggregation measurement result being a fifth value indicates that the second STA is not allowed to report multiple measurement results from different measurement instances simultaneously in a sensing measurement reporting frame triggered by the sensing measurement reporting trigger frame.

For example, when the value of the field for indicating whether to report the aggregation measurement result is 1, it indicates that aggregation reporting is permitted (i.e., the second STA is allowed to simultaneously report multiple measurement results from different measurement instances in a sensing measurement reporting frame triggered by the sensing measurement reporting trigger frame), and when the value is 0, it indicates that aggregation reporting is not possible (i.e., the second STA is not allowed to simultaneously report multiple measurement results from different measurement instances in a sensing measurement reporting frame triggered by the sensing measurement reporting trigger frame). The above values are only examples, and the embodiments of the present disclosure may also use other values to indicate whether aggregation reporting is permitted.

In a possible implementation, a frame carrying the sensing measurement reporting dependent information may be a sensing measurement reporting frame.

In a possible implementation, the communication device may be a second device. The second device may transmit a frame carrying sensing measurement reporting dependent information. For example, the second device may transmit a sensing measurement reporting frame carrying sensing measurement reporting dependent information to the first device. The second device may include a non-access point station (may be referred to as a STA), and the first device may include an access point station (may be referred to as an AP).

Alternatively, in a possible implementation, the communication device may be the first device. The first device may receive a frame carrying sensing measurement reporting dependent information. For example, the first device may receive a sensing measurement reporting frame carrying sensing measurement reporting dependent information from the second device. The first device may include an access point station (may be referred to as an AP), and the second device may include a non-access point station (may be referred to as a STA).

The transmission of the sensing measurement reporting frame may be triggered by a sensing measurement reporting trigger frame. For example, after triggered by receiving the sensing measurement reporting trigger frame from the first device, the second device performs sensing measurement and transmits the sensing measurement result to the first device through the sensing measurement reporting frame.

In a possible implementation, the sensing measurement reporting dependent information includes at least one of channel state information (Channel State Information, CSI) type of sensing measurement result data, truncated channel impulse response (Truncated Channel Impulse Response, TCIR) type of sensing measurement result data, or extended (Extended) type of sensing measurement result data.

Herein, the CSI type of sensing measurement result data may be carried in a CSI type of sensing measurement report element of the sensing measurement reporting frame; or, the TCIR type of sensing measurement result data may be carried in a TCIR type of sensing measurement report element of the sensing measurement reporting frame; or, the sensing measurement result data in the extended type may be carried in an extended type of sensing measurement report element of the sensing measurement reporting frame.

In a possible implementation, the CSI type of sensing measurement report element or the TCIR type of sensing measurement report element includes at least one of.
a field for indicating an element identifier;
a field for indicating a length;
a field for indicating element identifier extension;
a field for indicating a sensing measurement setup identifier (ID);
a field for indicating a sensing measurement instance identifier (ID);
a field for indicating a sensing measurement timestamp;
a field for indicating sensing measurement result control; or
a field for indicating sensing measurement result data.

In a possible implementation, a value of the field for indicating the element identifier extension being a sixth value indicates the CSI type of sensing measurement report element; For example, a value of the field for indicating the element identifier extension being 100 indicates that the extended element is a sensing measurement report element (CSI). The aforementioned values are only examples. The embodiments of the present disclosure may also adopt any integer value between 94 and 255 or other values to indicate that the extended element is a sensing measurement report element (CSI).

Alternatively, a value of the field for indicating the element identifier extension being a seventh value indicates the TCIR type of sensing measurement report element. For example, a value of the field for indicating the element identifier extension being 101 indicates that the extended element is a sensing measurement report element (TCIR). The aforementioned values are only examples. The embodiments of the present disclosure may also adopt any integer value between 94 and 255 or other values to indicate that the extended element is a sensing measurement report element (TCIR).

In a possible implementation, the field for indicating the sensing measurement result control in the CSI type of sensing measurement report element includes at least one of:
a field for indicating a number of columns of a CSI matrix;
a field for indicating a number of rows of a CSI matrix;
a field for indicating a channel bandwidth;
a field for indicating partial bandwidth information;
a field for indicating a coding mode of CSI data for reporting;
a field indicating a number of coding bits;
a field for indicating a grouping factor;
a field for indicating a measurement frame (NDP) type; or
a reserved field.

In a possible implementation, the field for indicating the sensing measurement result control in the TCIR type of sensing measurement report element includes at least one of:
a field for indicating a number of columns of a TCIR matrix;
a field for indicating a number of rows of a TCIR matrix;
a field for indicating a channel bandwidth;
a field for indicating a TCIR type;
a field for indicating a coding mode of TCIR data for reporting;
a field indicating a number of coding bits;
a field for indicating a length of a TCIR segment;
a field for indicating a number of TCIR segments;
a field for indicating a TCIR segment list;
a field for indicating an NDP type; or
a reserved field.

In a possible implementation, a coding mode of CSI data or a coding mode of TCIR data includes at least one of low-complexity direct coding, low-complexity differential coding, or phase coding.

Herein, the low-complexity direct coding includes at least one of following steps:
calculating a scaling factor;
linearly scaling a real part and an imaginary part of an element in a matrix according to the scaling factor, and quantizing scaled real part and imaginary part into multiple intervals; or
performing direct coding on quantized data.

Herein, the low-complexity differential coding includes at least one of following steps:
calculating a scaling factor;
linearly scaling a real part and an imaginary part of an element in a matrix according to the scaling factor, and quantizing scaled real part and imaginary part into multiple intervals; or
performing differential coding on quantized data.

In a possible implementation, the extended type of sensing measurement report element includes at least one of:
a field for indicating an element identifier;
a field for indicating a length;
a field for indicating element identifier extension;
a field for indicating a sensing measurement setup identifier;
a field for indicating a sensing measurement instance identifier;
a field for indicating an NDP type;
a field for indicating HE-SIG-A/U-SIG information; or
a field for indicating a carrier frequency offset (CFO).

In a possible implementation, a value of the field for indicating the element identifier extension being an eighth value indicates the extended type of sensing measurement report element. For example, a value of the field for indicating the element identifier extension being 102 indicates that the extended element is a sensing measurement report element (Extended). The aforementioned values are only examples. The embodiments of the present disclosure may also adopt any integer value between 94 and 255 or other values to indicate that the extended element is a sensing measurement report element (Extended).

In a possible implementation, at least one of the CSI type of sensing measurement report element, the TCIR type of sensing measurement report element, or the extended type of sensing measurement report element is carried in a field of the sensing measurement reporting frame for indicating a sensing measurement report list; and the field for indicating the sensing measurement report list is carried in a field of the sensing measurement reporting frame for indicating an action domain.

In a possible implementation, the field for indicating the action domain further includes at least one of.
a field for indicating an action type;
a field for indicating a common action subtype; or
a field for indicating a sensing subtype.

In a possible implementation, a value of the field for indicating the action type being an eighth value indicates that the sensing measurement reporting frame belongs to a common action frame; For example, a value of the field for indicating the action type being 4 indicates that the frame is a common action frame. The aforementioned values are only examples, and the embodiments of the present disclosure may also adopt other values to indicate that the frame is a common action frame.

Alternatively, a value of the field for indicating the common action subtype being a ninth value indicates that the sensing measurement reporting frame belongs to a sensing action frame; for example, the value of the field for indicating the common action subtype being 46 indicates that the frame is a sensing action frame. The aforementioned values are only examples. The embodiments of the present disclosure may also use any integer between 46 and 255 or other values to indicate that the frame is a common action frame.

Alternatively, a value of the field for indicating the sensing subtype being a tenth value indicates a sensing measurement reporting frame. For example, a value of the field for indicating the sensing subtype being 6 indicates that the frame is a sensing measurement reporting frame. The aforementioned values are only examples. The embodiments of the present disclosure may also adopt any numerical value or other value in the range of 0 to 255 to indicate that the frame is a sensing measurement reporting frame.

In a possible implementation, the field for indicating the action domain further includes at least one of.
a field for indicating an action type; or
a field for indicating a sensing action subtype.

In a possible implementation, a value of the field for indicating the action type being an eleventh value indicates that the sensing measurement reporting frame belongs to a newly defined sensing action frame; for example, the value of the field for indicating the action type being 40 indicates that the frame is a newly defined sensing action frame. The aforementioned values are only examples. The embodiments of the present disclosure may also adopt any numerical value in the range of 38 to 125 or other values to indicate that the frame is a newly defined sensing action frame.

Alternatively, a value of the field for indicating the sensing action subtype being a twelfth value indicates a sensing measurement reporting frame; for example, a value of the field for indicating the sensing action subtype being 6 indicates that the frame is a sensing measurement reporting frame. The aforementioned values are only examples. The embodiments of the present disclosure may also adopt any numerical value or other value in the range of 0 to 255 to indicate that the frame is a sensing measurement reporting frame.

The above-mentioned embodiments of the present disclosure involve multiple sensing measurement reporting trigger frames and frame formats of sensing measurement reporting frames in the sensing reporting phase, which can better support sensing measurement reporting. Referring to FIG. 3, the frame format provided in the embodiments of the present disclosure mainly relates to the sensing reporting phase in the overall process of WIFI sensing. The following describes in detail examples of the frame formats provided in the embodiments of the present disclosure.

In the sensing reporting phase, at least one of the following frame formats may be provided: a sensing measurement reporting trigger frame and a sensing measurement reporting frame. Herein, the sensing measurement reporting trigger frame may include a sensing measurement reporting trigger frame for triggering uplink EHT TB PPDU transmission and a sensing measurement reporting frame trigger frame for triggering uplink HE TB PPDU transmission; the sensing measurement reporting frame may include a common action frame based sensing measurement reporting frame and a newly defined action frame based sensing measurement reporting frame. The frame formats of the aforementioned various frames are introduced in detail below.

### 1. Sensing Measurement Reporting Trigger Frame:

The sensing measurement reporting trigger frame is used in the sensing reporting phase and can allocate a resource for the s sensing measurement reporting frame to be sent by the STA subsequently.

The sensing measurement reporting trigger frame may be used to trigger a transmission of an EHT TB PPDU carrying the sensing measurement reporting frame in the uplink or a transmission of an HE TB PPDU carrying the sensing measurement reporting frame in the uplink. When the sensing measurement reporting trigger frame is used to trigger a transmission of the uplink EHT TB PPDU, the 54th and 55th bits of the common information field are both set to 0; when the sensing measurement reporting trigger frame is used to trigger a transmission of the uplink HE TB PPDU, the 54th and 55th bits of the common information field are both set to 1.

When the sensing measurement reporting trigger frame is used to trigger a transmission of the uplink EHT TB PPDU, the sensing measurement reporting trigger frame includes an EHT variant common information field and an EHT variant user information field. When the sensing measurement reporting trigger frame is used to trigger a transmission of the uplink HE TB PPDU, the sensing measurement polling trigger frame includes the HE variant common information field and the HE variant user information field.

### 1.1 Sensing Measurement Reporting Trigger Frame for Triggering a Transmission of Uplink EHT TB PPDU

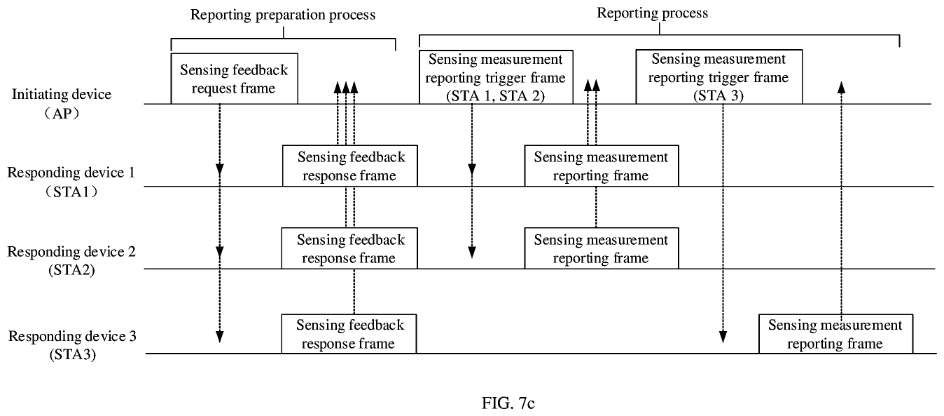

As shown in FIG. 9, a sensing measurement reporting trigger frame (Sensing Feedback Poll Trigger frame) for triggering a transmission of an uplink EHT TB PPDU is provided, which is a new trigger frame, and includes the following fields:
frame type (Type): a value being 1 indicates that the frame is a control frame;
frame subtype (Subtype): a value being 2 indicates that the frame is a trigger frame;
EHT variant common information (EHT variant Common Info): information applied to the STA identified by each user information in the user information list;
trigger frame type (Trigger Type): a value being 9 indicates that the frame is a sensing trigger frame (any of the reserved values 9 to 15 can be used to indicate that the frame is a sensing trigger frame);
uplink length (UL Length): indicating a value of the L-SIG LENGTH field in the uplink EHT TB PPDU triggered by this trigger frame;
whether there are more trigger frames (More TF): indicating whether there are other trigger frames to be sent after this trigger frame is sent. A value being 1 indicates yes and a value being 0 indicates no, or a value being 0 indicates yes and a value being 1 indicates no;
whether carrier sensing is required (CS Required): indicating that the STA identified in the user information field needs to use energy detection (Energy Detection, ED) to sense the medium and consider the medium state and network allocation vector (Network Allocation Vector, NAV) to decide whether to respond. A value being 1 indicates yes and a value being 0 indicates no, or a value being 0 indicates yes and a value being 1 indicates no;
uplink bandwidth (UL BW): this field and the UL bandwidth Extension (UL BW Extension) subfield in the “Special User Information” field together indicate a bandwidth used by the EHT TB PPDU. See Table 1 for specific values and meanings thereof:

TABLE 1
Coding meaning of the uplink bandwidth field
and the uplink bandwidth extension subfield

| UL bandwidth | UL bandwidth extension | EHT TB PPDU bandwidth |
|---|---|---|
| 0 | 0 | 20 MHz |
| 0 | 1 | Reserved |
| 0 | 2 | Reserved |
| 0 | 3 | Reserved |
| 1 | 0 | 40 MHz |
| 1 | 1 | Reserved |
| 1 | 2 | Reserved |
| 1 | 3 | Reserved |
| 2 | 0 | 80 MHZ |
| 2 | 1 | Reserved |
| 2 | 2 | Reserved |
| 2 | 3 | Reserved |
| 3 | 0 | Reserved |
| 3 | 1 | 160 |
| 3 | 2 | 320-1 |
| 3 | 3 | 320-2 |

GI and EHT-LTF type (GI And EHT-LTF Type): indicating types of the guard interval (Guard Interval, GI) and EHT-LTF (Long Training Field) used by the uplink EHT TB PPDU triggered by this trigger frame. See Table 2 for specific values and meanings thereof:

TABLE 2
Meaning of the guard interval and EHT-LTF type field

| Value | Guard interval and EHT-LTF type |
|---|---|
| 0 | 1 × EHT-LTF + 1.6 μs GI |
| 1 | 2 × EHT-LTF + 1.6 μs GI |
| 2 | 4 × EHT-LTF + 3.2 μs GI |
| 3 | Reserved |

number of EHT-LTF symbols (Number Of EHT-LTF Symbols): indicating a number of EHT-LTF symbols used by the uplink EHT TB PPDU triggered by the trigger frame. See Table 3 for specific values and meanings thereof:

TABLE 3
Meaning of the number of EHT-LTF symbols field

| Value | Number of EHT-LTF symbols |
|---|---|
| 0 | 1 EHT-LTF |
| 1 | 2 EHT-LTF |
| 2 | 4 EHT-LTF |
| 3 | 6 EHT-LTF |
| 4 | 8 EHT-LTF |
| 5-7 | Reserved |

LDPC extra symbol segment (LDPC Extra Symbol Segment): indicating a state of the low density parity check (Low Density Parity Check, LDPC) extra symbol segment. The field of LDPC extra symbol segment being a value of 1 indicates that there is an LDPC extra symbol segment in an uplink EHT TB PPDU triggered by the trigger frame, and the field of LDPC extra symbol segment being a value of 0 indicates that there is no LDPC extra symbol segment in the uplink EHT TB PPDU triggered by the trigger frame;
AP transmission power (AP Tx Power): indicating an AP combined transmission power of all antennas used to trigger PPDU on the transmission antenna connector. The AP combined transmission power is in a unit of dBm/20 MHz;
Pre-FEC padding factor (Pre-FEC Padding Factor): indicating a pre-FEC padding factor of the uplink EHT TB PPDU triggered by the trigger frame. See Table 4 for specific values and meanings thereof:

TABLE 4
Meaning of the pre-FEC padding factor field

| Value | Pre-FEC padding factor |
|---|---|
| 0 | 4 |
| 1 | 1 |
| 2 | 2 |
| 3 | 3 |

PE disambiguity (PE Disambiguity): indicating the PE disambiguity of the uplink EHT TB PPDU triggered by the trigger frame. If formula (1) is satisfied, a value of this field is 1. If formula (1) is not satisfied, a value of this field is 0.

$${T}_{PE} + 4 \times ( ⌈ \frac{TXTIME - SignalExtension - 20}{4} ⌉ - ( \frac{TXTIME - SignalExtension - 20}{4} ) ) \geq {T}_{SYM} \qquad Formula ( 1 )$$

where T_{PE} is the length of PE field, T_{SYM} is the symbol length of data field, TXTIME is packet transmission time, SignalExtension is 0 if NO_SIG_EXTN in TXVECTOR is true, and SignalExtension is aSignalExtension if NO_SIG_EXTN in TXVECTOR is false;
UL Spatial Reuse (UL Spatial Reuse): indicating a value of a spatial reuse field of a HE-SIG-A field of the uplink EHT TB PPDU triggered by the trigger frame;
HE/EHT primary 160 MHz (HE/EHT P160): indicating that an uplink TB PPDU triggered by the trigger frame in the primary 160 MHz is a HE TB PPDU or an EHT TB PPDU. A value of this field being 0 indicates that the uplink TB PPDU triggered by the trigger frame in the primary 160 MHz is an EHT TB PPDU, and a value of this field 1 represents that an uplink TB PPDU triggered by the trigger frame in the primary 160 MHz is a HE TB PPDU;
special user information field flag (Special User Info Field Flag): indicating whether a special user information field is included in the trigger frame. A value of the field of special user information field flag being 0 indicates that the special user information field flag is included in the trigger frame, and a value of 1 indicates that the special user information field flag is not included in the trigger frame. The value of the above field in the EHT variant common information field being always 0 indicates that a trigger frame of the EHT variant common information field includes a special user information field. When the sensing measurement poll trigger frame is used to trigger the transmission of the uplink EHT TB PPDU, the 54th bit (HE/EHT P160 field) and the 55th bit (Special User Info Field Flag field) of the EHT variant common information field of are both set to 0.

The sensing measurement reporting trigger frame may further include a trigger frame type dependent common information field:
trigger frame type dependent common information (Trigger Dependent Common Info): indicating information applied to each user in the user information list. The length of this field is a positive integer multiple of 8 bits, such as 8, 16, 24, or 32 bits. The length value (32 bits) in this embodiment is only for illustration.

The trigger frame type dependent common information field may include the following fields:
sensing trigger frame subtype (Sensing Subtype): a value being 2 indicates that the frame is a sensing measurement reporting trigger frame (Sensing Feedback Trigger Frame). It can also be any value from 0 to 15 or other values, so as to indicate that the frame is a sensing measurement reporting trigger frame;
sensing measurement instance (Sensing Measurement Instance): indicating the sensing measurement instance to which the sensing measurement reporting trigger frame belongs, which can be uniquely identified by the following two fields: sensing measurement setup ID (Sensing Measurement Setup ID) field:
   indicating an identifier of the sensing measurement setup of the sensing measurement instance to which the sensing measurement reporting trigger frame belongs.
   sensing measurement instance ID (Sensing Measurement Instance ID) field: indicating an identifier of the sensing measurement instance to which the sensing measurement reporting trigger frame belongs. The identifier increments by 1 from 0 to 255, and then starts for re-incrementation from 0 after reaching 255.

The trigger frame type dependent common information field may further include a reserved field.

The sensing measurement reporting trigger frame may further include a user information list field.

Herein, user information list (User Info List): containing a collection of zero or more user information fields. The user information list field may include the following fields:
special user information (Special User Info): not carrying special user information, but carrying common information expect the EHT variant common information field;
EHT variant user information (EHT variant User Info): carrying information used for a specific STA.

Herein, the special user information field may include the following fields:
identification ID (AID12): a value of the AID12 field being a fixed value of 2007 indicates that the user information field is a special user information field;
PHY version identifier: indicating a PHY version of the TB PPDU triggered by this trigger frame (except HE TB PPDU). See Table 5 for the specific values and meanings thereof.

TABLE 5
Meaning of PHY version identifier field

| Value | PHY version identifier |
|---|---|
| 0 | EHT |
| 1-7 | Reserved |

uplink bandwidth extension (UL Bandwidth Extension): indicating a bandwidth of the TB PPDU obtained by the trigger frame triggering an EHT STA together with the UL bandwidth field of the EHT variant common information field. See Table 1 for specific values of this field and meanings thereof,
EHT spatial reuse 1 (EHT Spatial Reuse 1): carrying a value of a field of spatial reuse 1 in a U-SIG field of the EHT TB PPDU triggered by the trigger frame;
EHT spatial reuse 2 (EHT Spatial Reuse 2): carrying a value of a field of spatial reuse 2 in a U-SIG field of the EHT TB PPDU triggered by the trigger frame;
U-SIG disregard and validate (U-SIG Disregard And Validate): carrying a value of a disregard (Disregard) and validate (Validate) field in the U-SIG field of the EHT TB PPDU triggered by the trigger frame;
a reserved field.

The above EHT variant user information field may include the following fields:
identification ID (AID12/UID12): an identifier of a terminal;
resource unit allocation (RU Allocation): resource unit (resource unit) allocation information for the terminal;
uplink forward error correction coding scheme (UL FEC Coding Type): indicating the channel coding type used by the uplink EHT TB PPDU triggered by the trigger frame. A value being 0 indicates BCC coding, and a value being 1 indicates LDPC coding;
uplink EHT modulation and coding strategy (UL EHT-MCS): indicating a modulation coding strategy used by the uplink EHT TB PPDU triggered by the trigger frame;
spatial stream allocation (SS Allocation): indicating spatial stream (spatial stream) allocation information used by the uplink EHT TB PPDU triggered by the trigger frame;
uplink target receive power (UL Target Receive Power): indicating an expected power of an average received signal of each antenna measured by the uplink EHT TB PPDU triggered by the trigger frame on an antenna connector of the AP;
primary/secondary 160 MHz (PS160): an allocation scheme of resource units with a resource unit allocation field;
trigger frame type dependent user information (Trigger Dependent User Info): indicating information of a STA indicated by an identification field in the EHT variant user information field where the field is located,
where the trigger frame type dependent user information field may include a field for reporting an aggregation measurement result and a reserved field;
whether to report an aggregation measurement result: indicating whether a specific STA can simultaneously report multiple measurement results from different measurement instances in a sensing measurement reporting frame triggered by this trigger frame. A value being 1 indicates that aggregation reporting is permitted, and a value of 0 indicates that aggregation reporting is not possible.

### 1.2. Sensing Measurement Reporting Trigger Frame for Triggering a Transmission of Uplink HE TB PPDU

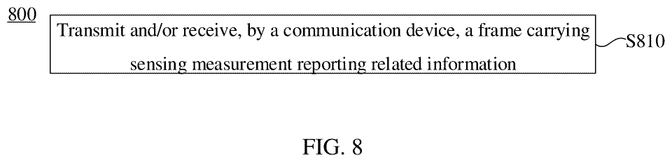

As shown in FIG. 10, a sensing measurement report trigger frame (Sensing Measurement Report Trigger frame) for triggering uplink HE TB PPDU transmission is provided, which is a new trigger frame and includes the following fields:
frame type (Type): a value being 1 indicates that the frame is a control frame;
frame subtype (Subtype): a value being 2 indicates that the frame is a trigger frame;
HE variant common information (HE variant Common Info): information applied to the STA identified by each user information in the user information list.

The following describes the fields contained in the HE variant common information field:
trigger frame type (Trigger Type): a value being 9 indicates that the frame is a sensing trigger frame (any of the reserved values 9 to 15 can be used to indicate that the frame is a sensing trigger frame);
uplink length (UL Length): indicating a value of the L-SIG LENGTH field in the uplink HE TB PPDU triggered by this trigger frame;
whether there are more trigger frames (More TF): indicating whether there are other trigger frames to be sent after this trigger frame is sent. A value being 1 indicates yes and a value being 0 indicates no, or a value being 0 indicates yes and a value being 1 indicates no;
uplink bandwidth (UL BW): indicating a bandwidth used by the uplink HE TB PPDU triggered by this trigger frame. See Table 6 for specific value and meaning thereof:

TABLE 6
Meaning of the uplink bandwidth field

| Value | Uplink bandwidth |
|---|---|
| 0 | 20 MHz |
| 1 | 40 MHz |
| 2 | 80 MHZ |
| 3 | 80 + 80 MHz or 160 MHz |

GI and HE-LTF type (GI And HE-LTF Type): indicating types of the guard interval (Guard Interval, GI) and HE-LTF (Long Training Field) used by the uplink HE TB PPDU triggered by this trigger frame. See Table 7 for specific values and meanings thereof:

TABLE 7
Meaning of the guard interval and HE-LTF type field

| Value | Guard interval and HE-LTF type |
|---|---|
| 0 | 1 × HE-LTF + 1.6 μs GI |
| 1 | 2 × HE-LTF + 1.6 μs GI |
| 2 | 4 × HE-LTF + 3.2 μs GI |
| 3 | Reserved |

MU-MIMO HE-LTF mode: indicating the HE-LTF mode used by the HE TB PPDU that uses the full bandwidth resources and is allocated to multiple non-AP STAs in a case where the GI and HE-LTF fields indicate 2×HE-LTF+1.6 μs GI or 4×HE-LTF+3.2 μs GI; otherwise, this field is used to indicate the single stream pilot HE-LTF mode. See Table 8 for specific values and meanings thereof:

TABLE 8
Meaning of the MU-MIMO HE-LTF mode field

| Value | MU-MIMO HE-LTF mode |
|---|---|
| 0 | HE single stream pilot HE-LTF mode |
| 1 | HE masked HE-LTF sequence mode |

number of HE-LTF symbols and midamble periodicity (Number Of HE-LTF Symbols And Midamble Periodicity): this field indicates the number of HE-LTF symbols used by the uplink HE TB PPDU triggered by the trigger frame in a case where the Doppler field is 0. See Table 9 for the specific values and meanings thereof:

TABLE 9
Meaning of the number of HE-LTF symbols field

| Value | Number of HE-LTF symbols |
|---|---|
| 0 | 1 HE-LTF |
| 1 | 2 HE-LTF |
| 2 | 4 HE-LTF |
| 3 | 6 HE-LTF |
| 4 | 8 HE-LTF |
| 5-7 | Reserved |

When the Doppler field is 1, this field indicates the number of HE-LTF symbols and midamble periodicity used by the uplink PIE TB PPDU triggered by the trigger frame. See Table 10 for specific values and meanings thereof:

TABLE 10
Meaning of the number of HE-LTF symbols
and midamble periodicity field

| Value | Number of HE-LTF symbols and midamble periodicity |
|---|---|
| 0 | 1 HE-LTF and 10 symbol periods |
| 1 | 2 HE-LTF and 10 symbol periods |
| 2 | 4 HE-LTF and 10 symbol periods |
| 4 | 1 HE-LTF and 20 symbol periods |
| 5 | 2 HE-LTF and 20 symbol periods |
| 6 | 4 HE-LTF and 20 symbol periods |
| 3, 7 | Reserved |

uplink space time block coding (Space Time Block Coding, UL STBC): indicating whether the PIE TB PPDU triggered by the trigger frame uses space time block coding, where a value being 1 indicates that pace time block coding is used, and a value being 0 indicates that pace time block coding is not used;
LDPC extra symbol segment (LDPC Extra Symbol Segment): indicating a state of the low density parity check (Low Density Parity Check, LDPC) extra symbol segment. The field of LDPC extra symbol segment being a value of 1 indicates that there is an LDPC extra symbol segment in an uplink HE TB PPDU triggered by the trigger frame, and the field of LDPC extra symbol segment being a value of 0 indicates that there is no LDPC extra symbol segment in the uplink HE TB PPDU triggered by the trigger frame;
AP transmission power (AP Tx Power): indicating an AP combined transmission power of all antennas used to trigger PPDU on the transmission antenna connector. The AP combined transmission power is in a unit of dBm/20 MHz;
Pre-FEC padding factor (Pre-FEC Padding Factor): indicating a pre-FEC padding factor of the uplink EHT TB PPDU triggered by the trigger frame. See Table 4 for specific values and meanings thereof;
PE disambiguity (PE Disambiguity): indicating the PE disambiguity of the uplink HE TB PPDU triggered by the trigger frame. If formula (2) is satisfied, a value of this field is 1. If formula (2) is not satisfied, a value of this field is 0:

$${T}_{PE} + 4 \times ( ⌈ \frac{TXTIME - SignalExtension - 20}{4} ⌉ - ( \frac{TXTIME - SignalExtension - 20}{4} ) ) \geq {T}_{SYM} \qquad Formula ( 2 )$$

where T_{PE} is the length of PE field, T_{SYM} is the symbol length of data field, TXTIME is packet transmission time, SignalExtension is 0 if NO_SIG_EXTN in TXVECTOR is true, and SignalExtension is aSignalExtension if NO_SIG_EXTN in TXVECTOR is false;
UL Spatial Reuse (UL Spatial Reuse): indicateing a value of a spatial reuse field of a HE-SIG-A field of the uplink HE TB PPDU triggered by the trigger frame;
Doppler (Doppler): indicating whether there is a midamble in the HE TB PPDU triggered by the trigger frame, where a value being 1 indicates that there is a midamble, and a value being 0 indicates that there is no midamble;
uplink UL HE-SIG-A2 reserved (UL HE-SIG-A2 Reserved): carrying a value of a reserved field in a HE-SIG-A2 subfield of HE TB PPDUs triggered by the trigger frame. Values of the UL HE-SIG-A2 reserved fields are all set as 1;
trigger frame type dependent common information (Trigger Dependent Common Info) field: the definition of the trigger frame type dependent common information field may be the same as the trigger frame type dependent common information field of a sensing measurement reporting trigger frame used to trigger a transmission of an uplink EHT TB PPDU, which is not be repeated herein.

The sensing measurement reporting trigger frame may further include a user information list field:
user information list (User Info List): containing a collection of zero or more user information fields. The user information list field may include multiple HE variant user information fields:
   HE variant user information field (HE variant User Info): carries information applied to a specific STA. The HE variant user information field may include the following fields:
      resource unit allocation (RU Allocation): resource unit (resource unit) allocation information for the terminal.
      uplink forward error correction coding scheme (UL FEC Coding Type): indicating the channel coding type used by the uplink HE TB PPDU triggered by the trigger frame. A value being 0 indicates BCC coding, and a value being 1 indicates LDPC coding.
      uplink HE modulation and coding strategy (UL HE-MCS): indicating a modulation and coding strategy used by the HE TB PPDU triggered by the trigger frame.
      uplink dual carrier modulation (UL DCM): indicates whether the HE TB PPDU triggered by the trigger frame uses dual carrier modulation, where a value being 1 indicates that dual carrier modulation is used, and a value being 0 indicates that dual carrier modulation is not used.
      spatial stream allocation (SS Allocation): indicating spatial stream (spatial stream) allocation information used by the uplink HE TB PPDU triggered by the trigger frame.
      uplink target receive power (UL Target Receive Power): indicating an expected power of an average received signal of each antenna measured by the uplink HE TB PPDU triggered by the trigger frame on an antenna connector of the AP.
      trigger frame type dependent user information (Trigger Dependent User Info) field: the definition of the trigger frame type dependent common information field may be the same as the trigger frame type dependent common information field of a sensing measurement reporting trigger frame used to trigger a transmission of an uplink EHT TB PPDU, which is not be repeated herein.

### 2. Sensing Measurement Reporting Frame

### 2.1. Sensing Measurement Reporting Frame Based on Common Action Frame

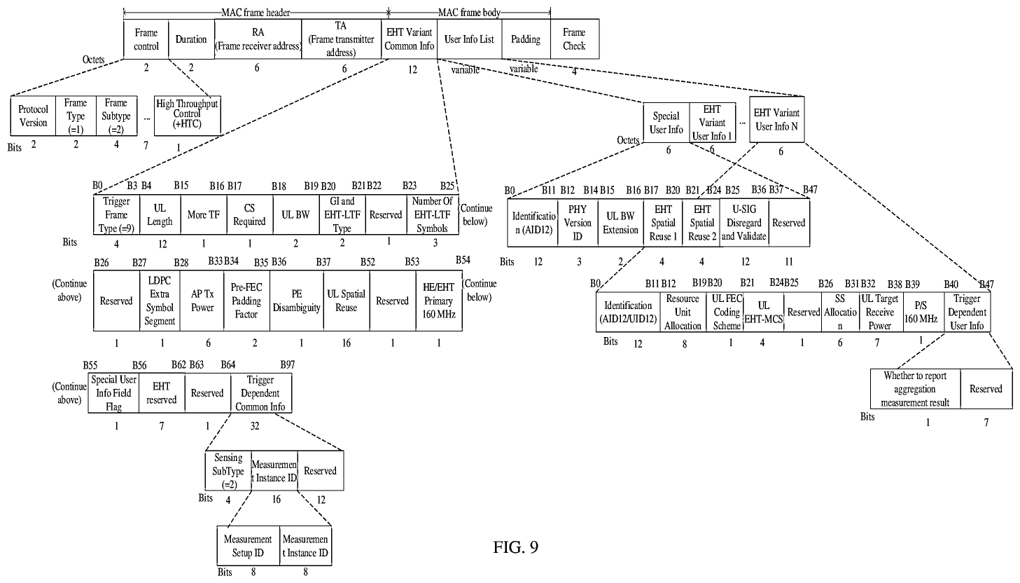

As shown in FIG. 11, a schematic diagram of a frame structure of a sensing measurement reporting frame based on a common action frame is provided, which is a new reporting frame and includes the following fields:
action type: a value being 4 indicates that the frame is a common action frame;
common action subtype: a value being 46 indicates that the frame is a sensing action frame. The value herein is only an example, and the actual value may be any integer within the range of 46 to 255;
sensing subtype (Sensing Subtype): a value being 6 (or any other value within the range of 0 to 255 may be used) indicates that the frame is a sensing measurement reporting frame;
sensing measurement report list: includes one or more sensing measurement report elements.

### 2.2. Sensing Measurement Reporting Frame Based on Newly Defined Action Frame

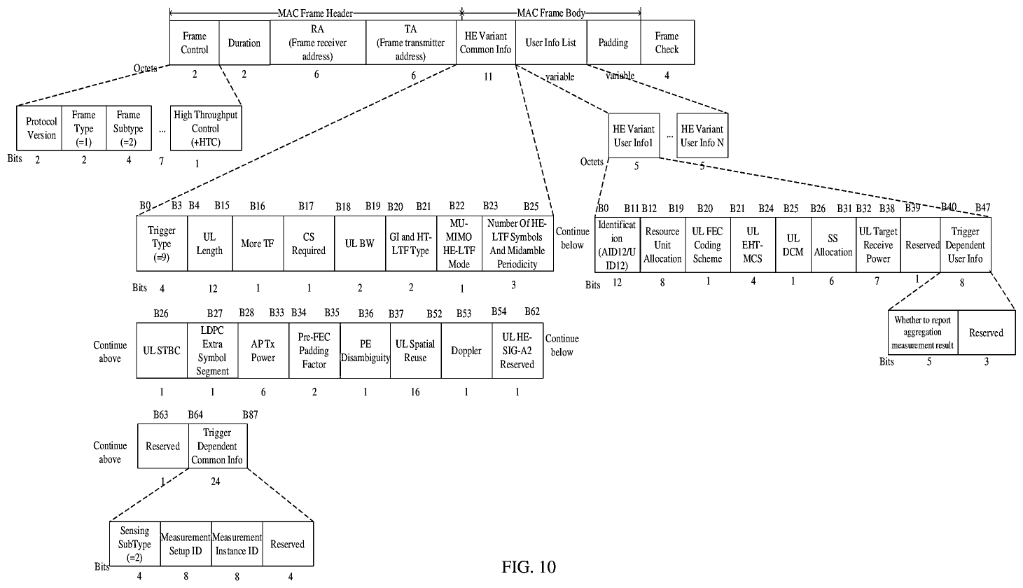

As shown in FIG. 12, a schematic diagram of the frame structure of a sensing measurement reporting frame based on a newly defined action frame is provided, which is a new reporting frame. The new reporting frame includes the action domain field, and the action domain field includes the following fields:
action type: a value being 40 (or any other value within the range of 38 to 125 may be used) indicates that the frame is a newly defined sensing action frame;
sensing action subtype: a value being 6 (or any other value within the range of 0 to 255 may be used) indicates that the frame is a sensing measurement reporting frame;
sensing measurement report list: includes one or more sensing measurement report elements.

For sensing measurement report elements in the sensing measurement reporting frame based on the common action frame and the sensing measurement reporting frame based on the newly defined action frame, the embodiments of the present disclosure propose three types of sensing measurement report element to carry CSI-type, TCIR-type, and extended-type of sensing measurement result data, respectively.

The following will describe the three types of sensing measurement report element.

### 3.1. Sensing Measurement Report Element (CSI)

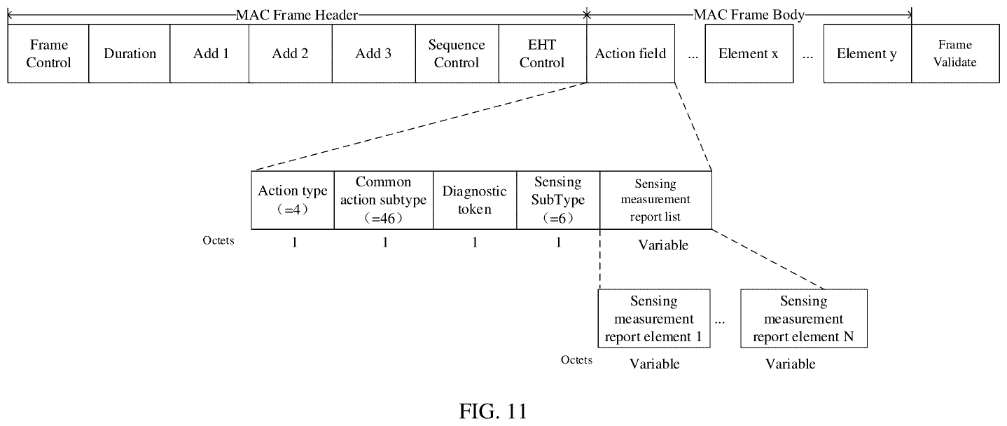

As shown in FIG. 13, a schematic diagram of a structure of a sensing measurement report element (CSI) is provided, which includes the following fields:
element identifier: a value being 255 indicates that the element is an extended element;
length: indicating the number of octets in an element excluding the element identifier field and the length field;
element identifier extension: a value being 100 (or any other integer value within the range of 94 to 255 may be used) indicates that the extended element is a sensing measurement report element (CSI);
sensing measurement setup ID: indicating parameter setting used to obtain the sensing measurement result for this time;
sensing measurement instance ID: indicating the sensing measurement instance corresponding to the sensing measurement result obtained for this time;
sensing measurement timestamp: indicating a time when the sensing measurement result is obtained for this time, specifically refers to the lower 4 octets sampled by the TSF timer when the MAC receives the PHY-CCA.indication(IDLE) primitive, corresponding to the end time for receiving an NDP;
sensing measurement result control: carrying the description information of “sensing measurement result data”;
sensing measurement result data: carrying CSI matrix data, whose size and type are indicated by the “sensing measurement result control” field.

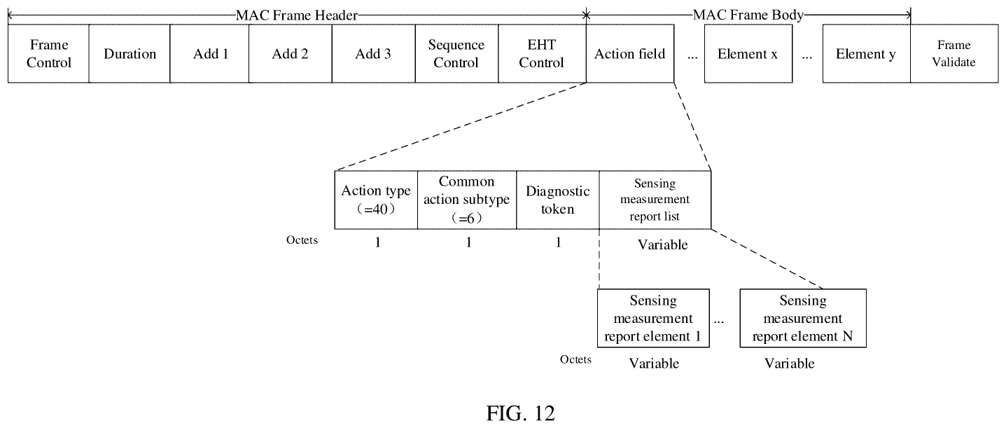

The sensing measurement result control field includes the following fields:
Nc: indicating the number of columns of a CSI matrix.
Nr: indicating the number of rows of a CSI matrix.
channel bandwidth: indicating a bandwidth of an NDP, which can be used to calculate the number of subcarriers in a CSI matrix.
partial bandwidth feedback information: indicating a range of effective subcarriers in the CSI matrix. The format of this field is shown in FIG. 14, where the “RU start index (RU Start Index)” subfield in the partial bandwidth information field indicates an index of the first 26-tone RU involved in the sensing measurement result data, and the “RU end index (RU End Index)” subfield indicates an index of the last 26-tone RU involved in the sensing measurement result data. The value of the “RU start index” subfield is less than or equal to the value of the “RU end index” subfield. The value range of the RU start index subfield and the RU end index subfield is determined by a bandwidth of an NDPA frame.
CSI type: indicating the type of a CSI matrix. See Table 11 for specific values and meanings thereof:

TABLE 11
CSI type field

| Value | CSI Type |
|---|---|
| 0 | Real part + imaginary part |
| 1 | Amplitude |
| 2 | Phase |
| 3 | Reserved |

coding mode of CSI data for reporting: indicating coding scheme for CSI data used by a responding device when reporting measurement results. See Table 12 for the values and meanings of this field. The value described in this field is only an exemplary introduction, and can also be set to other values, as long as the value corresponding to each coding mode of data for reporting is different from the values of other coding modes of data for reporting;

TABLE 12
Meaning of the coding mode of CSI data for reporting field

| Value | Report data coding mode |
|---|---|
| 0 | Basic coding |
| 1 | Low-complexity direct coding |
| 2 | Low-complexity differential coding |
| 3 | Phase coding |
| 4-8 | Reserved |

where:
   basic coding: indicating the coding mode defined by the 802.11n protocol^{[1]}, and applied to two CSI types: “real part+imaginary part” and “amplitude”.
   Low-complexity direct coding: indicating low-complexity amplitude coding mode, direct coding, and applied to two CSI types: “real part+imaginary part” and “amplitude”. The detailed process of this coding is listed in the following.
   Low-complexity differential coding: indicating low-complexity amplitude coding mode, differential coding, and applied to two CSI types: “real part+imaginary part” and “amplitude”. The detailed process of this coding is listed in the following.
   Phase coding: indicating a phase data coding mode (uniformly quantize the phase data in the range [0,2π) with a quantization step of 2π/2^{Nb}, and then encode it into Nb bits of data), and only applies to the “phase” CSI type.
number of coding bits (Nb): indicating the number of data coding bits used by the responding device when reporting the measurement results. See Table 13 for values and meanings thereof. The value described in this field is only an exemplary introduction, and can also be set to other values, as long as a value corresponding to the number of coding bits of each type of reported data is different from values of the numbers of coding bits of other types of reported data;

TABLE 13
Meaning of the coding bit number field

| Value | Number of coding bits of report data |
|---|---|
| 0 | 8 |
| 1 | 10 |
| 2 | 12 |
| 3 | 14 |
| 4 | 16 |
| 5-15 | Reserved |

grouping factor: indicating a grouping factor used when a responding device reports a measurement result in a data type. Example values and meanings thereof are shown in Table 14. The values of this field are only exemplary introduction, and can also be set to other values, as long as a value corresponding to each grouping factor is different from values of other grouping factors.

TABLE 14
Meaning of the grouping factor field

| Value | Grouping Factor |
|---|---|
| 0 | 1 |
| 1 | 2 |
| 2 | 4 |
| 3 | 8 |
| 4-7 | Reserved |

NDP Type: indicating a type of NDP used for sensing measurement. See Table 15 for specific values and meanings thereof:

TABLE 15
Meaning of NDP type field

| Value | NDP Type |
|---|---|
| 0 | HE sounding NDP |
| 1 | HE ranging NDP |
| 2 | EHT sounding NDP |
| 3-8 | Reserved |

Sensing measurement result data: carrying CSI matrix data, whose size and type are indicated by the “sensing measurement result control” field;
   When “CSI Type” indicates real part+imaginary part, the format of this field is as shown in Table 16:

TABLE 16
Format of sensing measurement result data (CSI type = real part + imaginary part)

| Field | Size (bits) | Meaning |
|---|---|---|
| RSSI | 8 | Received signal strength indicator |
| Scaling factor of | 3 | When the “report data coding mode” indicates the |
| subcarrier −N_{SR}, or | | basic coding scheme, this field is the scaling |
| scaling factor of | | factor of the subcarrier −N_{SR}; when the “coding |
| received RF link 1 | | scheme for data report” indicates the |
| | | low-complexity direct coding scheme or the |
| | | low-complexity differential coding scheme, this |
| | | field is the scaling factor of the first received RF |
| | | link |
| . . . | | |
| Scaling factor of | 3 | When the “report data coding mode” indicates the |
| subcarrier N_{SR}, or | | basic coding scheme, this field is the scaling |
| scaling factor of | | factor of the subcarrier N_{SR}; when the “coding |
| received RF link Nr | | scheme for data report” indicates the |
| | | low-complexity direct coding scheme or the |
| | | low-complexity differential coding scheme, this |
| | | field is the scaling factor of the Nr-th received RF |
| | | link |
| CSI complete matrix of | 2 × Nb × Nc × Nr | CSI complete matrix |
| subcarrier −N_{SR} | | |
| . . . | | |
| CSI complete matrix of | 2 × Nb × Nc × Nr | CSI complete matrix |
| subcarrier −1 | | |
| CSI complete matrix of | 2 × Nb × Nc × Nr | CSI complete matrix |
| subcarrier 1 | | |
| . . . | | |
| CSI complete matrix of | 2 × Nb × Nc × Nr | CSI complete matrix |
| subcarrier N_{SR} | | |

Note:
N_{SR} is an index of the maximum subcarrier, and −N_{SR} is an index of the minimum subcarrier.

When “CSI Type” indicates amplitude, the format of this field is as shown in Table 17:

TABLE 17
Format of sensing measurement result data (CSI type = amplitude)

| Field | Size (bits) | Meaning |
|---|---|---|
| RSSI | 8 | Received signal strength indicator |
| Scaling factor of | 3 | When the “report data coding mode” |
| subcarrier −N_{SR}, or | | indicates the basic coding scheme, |
| scaling factor of | | this field is the scaling factor of the |
| received RF link 1 | | subcarrier −N_{SR}; when the “coding |
| | | scheme for data report” indicates the |
| | | low-complexity direct coding |
| | | scheme or the low-complexity |
| | | differential coding scheme, this field |
| | | is the scaling factor of the first |
| | | received RF link |
| . . . | | |
| Scaling factor of | 3 | When the “report data coding mode” |
| subcarrier N_{SR}, or | | indicates the basic coding scheme, |
| scaling factor of | | this field is the scaling factor of the |
| received RF link Nr | | subcarrier N_{SR}; when the “coding |
| | | scheme for data report” indicates the |
| | | low-complexity direct coding |
| | | scheme or the low-complexity |
| | | differential coding scheme, this field |
| | | is the scaling factor of the Nr-th |
| | | received RF link |
| CSI complete matrix of | Nb × Nc × Nr | CSI amplitude matrix |
| subcarrier −N_{SR} | | |
| . . . | | |
| CSI complete matrix of | Nb × Nc × Nr | CSI amplitude matrix |
| subcarrier −1 | | |
| CSI complete matrix of | Nb × Nc × Nr | CSI amplitude matrix |
| subcarrier 1 | | |
| . . . | | |
| CSI complete matrix of | Nb × Nc × Nr | CSI amplitude matrix |
| subcarrier N_{SR} | | |

When “CSI Type” indicates phase, the format of this field is as shown in Table 18.

TABLE 18
Format of sensing measurement result data (CSI type = phase)

| Field | Size (bits) | Meaning |
|---|---|---|
| CSI phase matrix of subcarrier −N_{SR} | Nb × Nc × Nr | CSI phase matrix |
| . . . | | |
| CSI phase matrix of subcarrier −1 | Nb × Nc × Nr | CSI phase matrix |
| CSI phase matrix of subcarrier 1 | Nb × Nc × Nr | CSI phase matrix |
| . . . | | |
| CSI phase matrix of subcarrier N_{SR} | Nb × Nc × Nr | CSI matrix |

In a possible implementation, the coding mode of the CSI complete matrix is as follows:

```
For each subcarrier include
{
  For each of Nr rows in each CSI matrix in order: (1, ..., Nr)
  {
    Include Nc complex coefficients of CSI matrix Heff in order: (1, ..., Nc);
    each element of Heff includes the real part of the element (Nb bits) and the
    imaginary part of the element (Nb bits) in that order
  }
}
That is,
For each subcarrier include
{
  For each row of CSI matrix with Nr rows: (1, ..., Nr)
  {
    Include Nc columns of CSI matrix elements: (1, ..., Nc);
    each CSI matrix element includes the real part of the element (Nb bits) and the
imaginary part of the element (Nb bits), with the real part in the first and the imaginary part in
the last
  }
}
```

In a possible implementation, the coding mode of the CSI amplitude matrix is as follows:

```
For each subcarrier include
{
  For each of Nr rows in each CSI matrix in order: (1, ..., Nr)
  {
    Include Nc complex coefficients of CSI matrix Heff in order: (1, ..., Nc);
    each element of Heff includes the amplitude part of the element (Nb bits);
  }
}
That is,
For each subcarrier include
{
  For each row of CSI matrix with Nr rows: (1, ..., Nr)
  {
    Include Nc columns of CSI matrix elements: (1, ..., Nc);
    each CSI matrix element includes the amplitude part of the element (Nb bits);
  }
}
```

In a possible implementation, the coding mode of the CSI phase matrix is as follows:

```
For each subcarrier include
{
  For each of Nr rows in each CSI matrix in order: (1, ..., Nr)
  {
    Include Nc complex coefficients of CSI matrix Heff in order: (1, ..., Nc);
    each element of Heff includes the phase part of the element (Nb bits);
  }
}
That is,
For each subcarrier include
{
  For each row of CSI matrix with Nr rows: (1, ..., Nr)
  {
    Include Nc columns of CSI matrix elements: (1, ..., Nc);
    each CSI matrix element includes the phase part of the element (Nb bits);
  }
}
```

### 3.2. Sensing Measurement Report Element (TCIR)

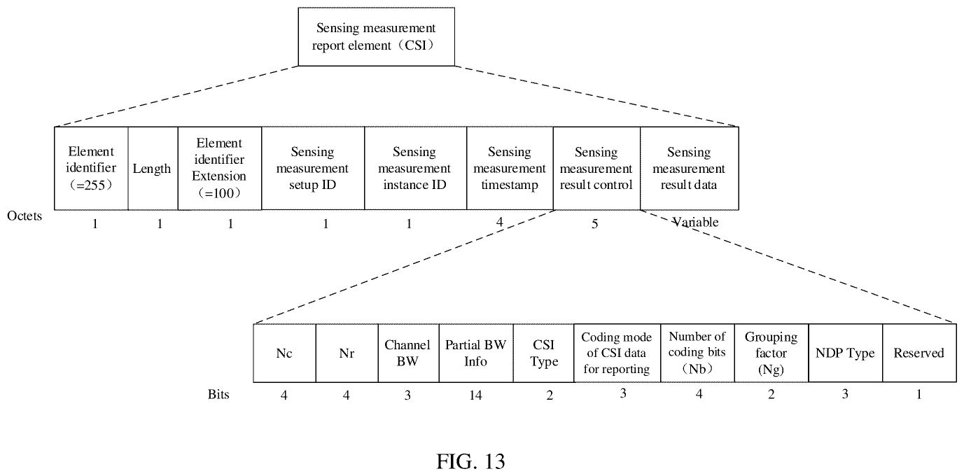

As shown in FIG. 15, a schematic diagram of a structure of a sensing measurement report element (TCIR) is provided, which includes the following fields:
element identifier: a value being 255 indicates that the element is an extended element;
length: indicates the number of octets in an element excluding the element identifier field and the length field;
element identifier extension: a value being 101 (or any other integer value within the range of 94 to 255 may be used) indicates that the extended element is a sensing measurement report element (TCIR);
sensing measurement setup ID: indicating parameter setting used to obtain the sensing measurement result for this time;
sensing measurement instance ID: indicating the sensing measurement instance corresponding to the sensing measurement result obtained for this time;
sensing measurement timestamp: indicating a time when the sensing measurement result is obtained for this time, specifically refers to the lower 4 octets sampled by the TSF timer when the MAC receives the PHY-CCA.indication(IDLE) primitive, corresponding to the end time for receiving the NDP;
sensing measurement result control: carrying the description information of “sensing measurement result data”;
sensing measurement result data: carrying a TCIR matrix, whose size and type are indicated by the “sensing measurement result control” field.

The sensing measurement result control includes the following fields:
Nc: indicating the number of columns of a TCIR matrix;
Nr: indicating the number of rows of a TCIR matrix;
Channel bandwidth: indicating a bandwidth of an NDP, which can be used to calculate the number of subcarriers in a CSI matrix and further calculate the maximum delay points of the TCIR matrix;
TCIR type: indicating the type of a TCTR matrix. See Table 19 for specific values and meanings thereof:

TABLE 19
TCIR type field

| Value | TCIR type |
|---|---|
| 0 | Real part + imaginary part |
| 1 | Amplitude |
| 2 | Phase |
| 3 | Reserved |

coding mode for reporting TCIR data: indicating coding scheme for TCTR data used by a responding device when reporting measurement results. See Table 20 for the values and meanings of this field. The value described in this field is only an exemplary introduction, and can also be set to other values, as long as the value corresponding to each coding mode of data for reporting is different from the values of other coding modes of data for reporting.

TABLE 20
Meaning of the coding scheme for TCIR data report field

| Value | coding scheme for TCIR data report |
|---|---|
| 0 | Basic coding |
| 1 | Low-complexity direct coding |
| 2 | Low-complexity differential coding |
| 3 | Phase coding |
| 4-8 | Reserved |

where,
   basic coding: indicating the coding mode defined by the 802.11n protocol^{[1]}. (the amplitude coding mode defined by the 802.11n protocol is used for CSI coding. Subcarrier k in the amplitude coding mode defined by the 802.11n protocol is replaced by delay t for TCIR coding), which is applied for “real part+imaginary part” and “amplitude” TCIR types.
   Low-complexity direct coding: indicating the low-complexity amplitude coding mode. Subcarrier k in the low-complexity direct coding mode in the sensing measurement report element (CSI) is replaced by delay t for TCIR coding), which is applied for “real part+imaginary part” and “amplitude” TCIR types.
   Low-complexity differential coding: indicating the low-complexity amplitude coding mode. Subcarrier k in the low-complexity differential coding mode in the sensing measurement report element (CSI) is replaced by delay t for TCTR coding), which is applied for “real part+imaginary part” and “amplitude” TCIR types.
   Phase coding: indicating a phase data coding mode (uniformly quantize the phase data in the range [0,2π) with a quantization step of 2π/2^{Nb}, and then encode it into Nb bits of data), and only applies to the “phase” TCTR type.
number of coding bits (Nb): indicating the number of data coding bits used by the responding device when reporting the measurement results. See Table 13 for values and meanings thereof;
TCTR segment length: indicating a number of delay points contained in each TCIR segment. See Table 21 for values and meanings thereof:

TABLE 21
Meaning of TCIR segment length field

| Value | TCIR segment length |
|---|---|
| 0 | 1 |
| 1 | 2 |
| 2 | 3 |
| 3 | 4 |

number of TCIR segments: indicating the number N_{SL} of TCIR segment start index subfields contained in the TCTR segment list. See Table 22 for values and meanings thereof:

TABLE 22
Meaning of number TCIR segments field

| Value | Number of TCIR segments |
|---|---|
| 0 | 1 |
| 1 | 2 |
| 2 | 3 |
| 3 | 4 |

TCTR segment list: including multiple TCTR segment starting indexes;
TCTR segment start index: indicating the index TSI of the first delay point of a TCTR segment. The start index of the first TCTR segment is TSI1, so the following relationship exists:

TCTR segment end index=TCTR segment start index (T_{SI})+TCIR segment length (N_{SL})−1
NDP Type: indicating a type of NDP used for sensing measurement. See Table 15 for specific values and meanings thereof;
a reserved field;
sensing measurement result data: carrying a TCIR matrix, whose size and type are indicated by the “sensing measurement result control” field.
   When “TCIR type” indicates real part+imaginary part, the format of this field is as shown in Table 23.

TABLE 23
Format of sensing measurement result data (TCIR type = real part + imaginary part)

| Field | Size (bits) | Meaning |
|---|---|---|
| RSSI | 8 | Received signal strength indicator |
| Scaling factor of delay point | 3 | When the “report data coding mode” |
| T_{SI}1, or | | indicates the basic coding scheme, this field |
| scaling factor of received RF | | is the scaling factor of the delay point T_{SI}1; |
| link 1 | | when the “report data coding mode” indicates |
| | | the low-complexity direct coding scheme or |
| | | the low-complexity differential coding |
| | | scheme, this field is the scaling factor of the |
| | | first received RF link |
| . . . | | |
| Scaling factor of delay point | 3 | When the “report data coding mode” |
| (T_{SI}4 + N_{SL} − 1), or | | indicates the basic coding scheme, this field |
| scaling factor of received RF | | is the scaling factor of the delay point (T_{SI}4 + |
| link Nr | | N_{SL} − 1); when the “report data coding mode” |
| | | indicates the low-complexity direct coding |
| | | scheme or the low-complexity differential |
| | | coding scheme, this field is the scaling factor |
| | | of the Nr-th received RF link |
| TCIR complete matrix of delay | 2 × Nb × Nc × Nr | TCIR complete matrix |
| point T_{SI}1 | | |
| . . . | | |
| TCIR complete matrix of delay | 2 × Nb × Nc × Nr | TCIR complete matrix |
| point (T_{SI}1 + N_{SL} − 1) | | |
| TCIR complete matrix of delay | 2 × Nb × Nc × Nr | TCIR complete matrix |
| point T_{SI}2 (optional) | | |
| . . . | | |
| TCIR complete matrix of delay | 2 × Nb × Nc × Nr | TCIR complete matrix |
| point (T_{SI}2 + N_{SL} − 1) (optional) | | |
| TCIR complete matrix of delay | 2 × Nb × Nc × Nr | TCIR complete matrix |
| point T_{SI}3 (optional) | | |
| . . . | | |
| TCIR complete matrix of delay | 2 × Nb × Nc × Nr | TCIR complete matrix |
| point (T_{SI}3 + N_{SL} − 1) (optional) | | |
| TCIR complete matrix of delay | 2 × Nb × Nc × Nr | TCIR complete matrix |
| point T_{SI}4 (optional) | | |
| . . . | | |
| TCIR complete matrix of delay | 2 × Nb × Nc × Nr | TCIR complete matrix |
| point (T_{SI}4 + N_{SL} − 1) (optional) | | |

When “TCTR type” indicates amplitude, the format of this field is as shown in Table 24.

TABLE 24
Format of sensing measurement result data (TCIR type = amplitude)

| Field | Size (bits) | Meaning |
|---|---|---|
| RSSI | 8 | Received signal strength indicator |
| Scaling factor of delay point | 3 | When the “report data coding mode” |
| T_{SI}1, or | | indicates the basic coding scheme, this field |
| scaling factor of received RF | | is the scaling factor of the delay point T_{SI}1; |
| link 1 | | when the “report data coding mode” |
| | | indicates the low-complexity direct coding |
| | | scheme or the low-complexity differential |
| | | coding scheme, this field is the scaling factor |
| | | of the first received RF link |
| . . . | | |
| Scaling factor of delay point | 3 | When the “report data coding mode” |
| (T_{SI}4 + N_{SL} − 1), or | | indicates the basic coding scheme, this field |
| scaling factor of received RF | | is the scaling factor of the delay point (T_{SI}4 + |
| link Nr | | N_{SL} − 1); when the “report data coding mode” |
| | | indicates the low-complexity direct coding |
| | | scheme or the low-complexity differential |
| | | coding scheme, this field is the scaling factor |
| | | of the Nr-th received RF link |
| TCIR amplitude matrix of delay | Nb × Nc × Nr | TCIR amplitude matrix |
| point T_{SI}1 | | |
| . . . | | |
| TCIR amplitude matrix of delay | Nb × Nc × Nr | TCIR amplitude matrix |
| point (T_{SI}1 + N_{SL} − 1) | | |
| TCIR amplitude matrix of delay | Nb × Nc × Nr | TCIR amplitude matrix |
| point T_{SI}2 (optional) | | |
| . . . | | |
| TCIR amplitude matrix of delay | Nb × Nc × Nr | TCIR amplitude matrix |
| point (T_{SI}2 + N_{SL} − 1) (optional) | | |
| TCIR amplitude matrix of delay | Nb × Nc × Nr | TCIR amplitude Matrix |
| point T_{SI}3 (optional) | | |
| . . . | | |
| TCIR amplitude matrix of delay | Nb × Nc × Nr | TCIR amplitude matrix |
| point (T_{SI}3 + N_{SL} − 1) (optional) | | |
| TCIR amplitude matrix of delay | Nb × Nc × Nr | TCIR amplitude matrix |
| point T_{SI}4 (optional) | | |
| . . . | | |
| TCIR amplitude matrix of delay | Nb × Nc × Nr | TCIR amplitude matrix |
| point (T_{SI}4 + N_{SL} − 1) (optional) | | |

When “TCIR type” indicates phase, the format of this field is as shown in Table 25.

TABLE 25
Format of sensing measurement result data (TCIR type = phase)

| Field | Size (bits) | Meaning |
|---|---|---|
| TCIR phase matrix of delay | Nb × Nc × Nr | TCIR amplitude matrix |
| point T_{SI}1 | | |
| . . . | | |
| TCIR phase matrix of delay | Nb × Nc × Nr | TCIR amplitude matrix |
| point (T_{SI}1 + N_{SL} − 1) | | |
| TCIR phase matrix of delay | Nb × Nc × Nr | TCIR amplitude matrix |
| point T_{SI}2 (optional) | | |
| . . . | | |
| TCIR phase matrix of delay | Nb × Nc × Nr | TCIR amplitude matrix |
| point (T_{SI}2 + N_{SL} − 1) | | |
| (optional) | | |
| TCIR phase matrix of delay | Nb × Nc × Nr | TCIR amplitude matrix |
| point T_{SI}3 (optional) | | |
| . . . | | |
| TCIR phase matrix of delay | Nb × Nc × Nr | TCIR amplitude matrix |
| point (T_{SI}3 + N_{SL} − 1) | | |
| (optional) | | |
| TCIR phase matrix of delay | Nb × Nc × Nr | TCIR amplitude matrix |
| point T_{SI}4 (optional) | | |
| . . . | | |
| TCIR phase matrix of delay | Nb × Nc × Nr | TCIR amplitude matrix |
| point (T_{SI}4 + N_{SL} − 1) | | |
| (optional) | | |

In a possible implementation, the coding mode of the TCTR complete matrix is as follows:

```
For each delay point include
{
  For each of Nr rows in each TCIR matrix in order: (1, ..., Nr)
  {
    Include Nc complex coefficients of TCIR matrix Heff in order: (1, ..., Nc);
    each element of Heff includes the real part of the element (Nb bits) and the
    imaginary part of the element (Nb bits) in that order
  }
}
That is,
For each delay point include
{
  For each row of TCIR matrix with Nr rows: (1, ..., Nr)
  {
    Include Nc columns of TCIR matrix elements: (1, ..., Nc);
    each TCIR matrix element includes the real part of the element (Nb bits) and the
  imaginary part of the element (Nb bits), with the real part in the first and the
imaginary part in the last
  }
}
```

In a possible implementation, the coding mode of the TCIR amplitude matrix is as follows:

```
For each delay point include
{
  For each of Nr rows in each TCIR matrix in order: (1, ..., Nr)
  {
    Include Nc complex coefficients of TCIR matrix Heff in order: (1, ..., Nc);
    each element of Heff includes the amplitude part of the element (Nb bits);
  }
}
That is,
For each delay point include
{
  For each row of TCIR matrix with Nr rows: (1, ..., Nr)
  {
    Include Nc columns of TCIR matrix elements: (1, ..., Nc);
    each TCIR matrix element includes the amplitude part of the element (Nb bits);
  }
}
```

In a possible implementation, the coding mode of the TCTR phase matrix is as follows:

```
For each delay point include
{
  For each of Nr rows in each TCIR matrix in order: (1, ..., Nr)
  {
    Include Nc complex coefficients of TCIR matrix Heff in order: (1, ..., Nc);
    each element of Heff includes the phase part of the element (Nb bits);
  }
}
That is,
For each delay point include
{
  For each row of TCIR matrix with Nr rows: (1, ..., Nr)
  {
    Include Nc columns of TCIR matrix elements: (1, ..., Nc);
    each TCIR matrix element includes the phase part of the element (Nb bits);
  }
}
```

### 3.3. Sensing Measurement Report Elements (Extended)

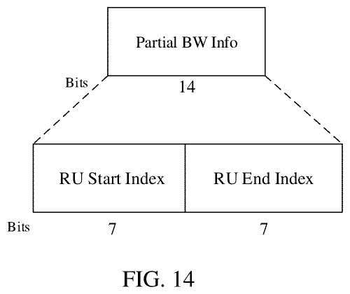

As shown in FIG. 16, a schematic diagram of a structure of a sensing measurement report element (Extended) is provided, which includes the following fields:
element identifier: a value being 255 indicates that the element is an extended element.
length: indicates the number of octets in an element excluding the element identifier field and the length field;
element identifier extension: a value being 102 (or any other integer value within the range of 94 to 255 may be used) indicates that the extended element is a sensing measurement report element (Extended);
sensing measurement setup ID: indicating parameter setting used to obtain the sensing measurement result for this time;
sensing measurement instance ID: indicating the sensing measurement instance corresponding to the sensing measurement result obtained for this time;
measurement frame (NDP, Null Data PPDU) type: indicating a type of NDP used for sensing measurement. See Table 15 for specific values and meanings thereof. HE-SIG-A/U-SIG information/U-SIG information: when a value of “NDP Type” indicates HE Sounding NDP or HE Ranging NDP, this field carries the HE-SIG-A/U-SIG information field in NDP (may not include CRC and/or Tail and/or Reserved fields); when a value of “NDP Type” indicates EHT Sounding NDP, this field carries the U-SIG field in NDP (may not include CRC and/or Tail and/or Disregard and/or Validate fields);
carrier frequency offset (Carrier Frequency Offset, CFO): carrying carrier frequency offset data of the sensing measurement for this time, which adopts a 32-bit single-precision floating point format, in units of (Hz).

The low-complexity coding mode proposed in the embodiments of the disclosure may include the following steps.
Scaling steps

There is a CSI matrix (H_{eff}) on each received RF link j. Each CSI matrix has N_{c}×N_{ST} elements, where N_{c} is the number of total spatial streams, and N_{ST} is the number of total subcarriers. Each element in the CSI matrix may be a complex number (a real part and an imaginary part) or a real number. The coding mode of real number element is similar to that of complex number element, which only needs to ignore the operation of the imaginary part and keep the operation of the real part.

Here, taking a complex element as an example to introduce the coding mode. The largest absolute value is found in all real data and imaginary data. The maximum absolute value of the j-th received RF link is:

$${m}_{H} ( j ) = max \{ max \{ {\vert Re ( {H}_{eff ( k , l )} ( j ) ) \vert}_{k = 1 , l = 1}^{k = {N}_{ST} , l = {N}_{c}} \} , max \{ {\vert Im ( {H}_{eff ( m , l )} ( j ) ) \vert}_{k = 1 , l = 1}^{k = {N}_{ST} , l = {N}_{c}} \} \} .$$

In the above formula, k and l are subcarrier index and spatial stream index, respectively; N_{ST} and N_{c} are rows and columns of the matrix and represents the number of subcarriers and spatial streams, respectively.

The real part and the imaginary part of the original CSI matrix are represented in binary complement format with Nₚ bits, and the value of Nₚ is specified by the equipment manufacturer.

Assume the scaling factor is α, let α=2^{r}, where r is called as a scaling factor and coded with 3 bits, so r∈{0, 1, 2, . . . , 7}, α∈{1, 2, 4, . . . , 128}. Use the scaling factor a to perform maximum quadratic scaling on m_{H}(j) in the case of avoiding overflow and satisfying the following inequality:

$${2}^{( {N}_{p} - 2 )} \leq α {m}_{H} ( j ) \leq {2}^{( {N}_{p} - 1 )} - 1.$$

According to the above formula, the value of the scaling factor r corresponding to the j-th received RF link can be obtained, and the value of r corresponds to the number of bits by which each real part and imaginary part in the CSI matrix is shifted left. This method replaces the conversion operations between linear value to dB value and dB value to linear value in the 802.1In standard with shift operations, which greatly reduces the complexity of the operation.
Quantization steps

The real and imaginary parts of the elements in the CSI matrix are linearly scaled according to the scaling factor and then quantized into 2^{N}^{_{b}} intervals, as shown below:

$${H}_{eff ( k , l )}^{q ( R )} ( j ) = ⌊ α Re \{ {H}_{eff ( k , l )} ( j ) \} ( {2}^{( {N}_{b} - {N}_{p} )} ) + 0.5 ⌋ , \\ {H}_{eff ( k , l )}^{q ( I )} ( j ) = ⌊ α Im \{ {H}_{eff ( k , l )} ( j ) \} ( {2}^{( {N}_{b} - {N}_{p} )} ) + 0.5 ⌋ .$$

In the above formula, └⋅┘ is the floor operation, └⋅ +0.5┘ is the rounding operation, and N_{b} is the number of coding bits of the real part and imaginary part data in the CSI matrix in the communication frame, which affects the volume of data fed back by the CSI.
Coding steps

The quantized data is directly coded into the binary complement form with N_{b} bits. Direct coding means coding each scaled and quantized value itself, that is, there is no relationship between H_{eff(k,l)}^{q(R)}(j−1) and H_{eff(k,l)}^{q(R)}(j) or between H_{eff(k,l)}^{q(R)}(j−1) and H_{eff(k,l)}^{q(I)}(j).

The low-complexity differential coding mode proposed in the embodiments of the disclosure may include the following steps.

The “scaling” step and “quantization” step are the same as that of the low-complexity coding mode, and the “coding” step is as follows:
performing differential coding on the quantized data to code it into the binary complement form with N_{b} bits. The differential coding refers to coding the variation of one data relative to the previous data, that is, coding on ΔH_{eff(k,l)}^{q(R)}(j)=H_{eff(k,l)}^{q(R)}(j)−H_{eff(k,l)}^{q(R)}(j−1) and ΔH_{eff(k,l)}^{q(I)}(j)=H_{eff(k,l)}q(j)−H_{eff(k,l)}^{q(I)}(j−1).

The embodiments of the present disclosure provide new frame formats used in the sensing measurement reporting phase in WIFI sensing, which include a sensing measurement reporting trigger frame for triggering a transmission of an uplink EHT TB PPDU, a sensing measurement reporting trigger frame for triggering a transmission of an uplink HE TB PPDU, a sensing measurement reporting frame based on a common action frame, a sensing measurement report frame based on a newly defined action frame. In addition, the embodiments of the present disclosure further propose three types of sensing measurement report element including: sensing measurement report element (CSI), sensing measurement report element (TCIR) and sensing measurement report element (Extended). Compared with the existing frame format, the frame formats proposed in the embodiments of the present disclosure transmits sensing measurement reporting dependent information, thereby supporting reporting of various types of sensing measurement results.

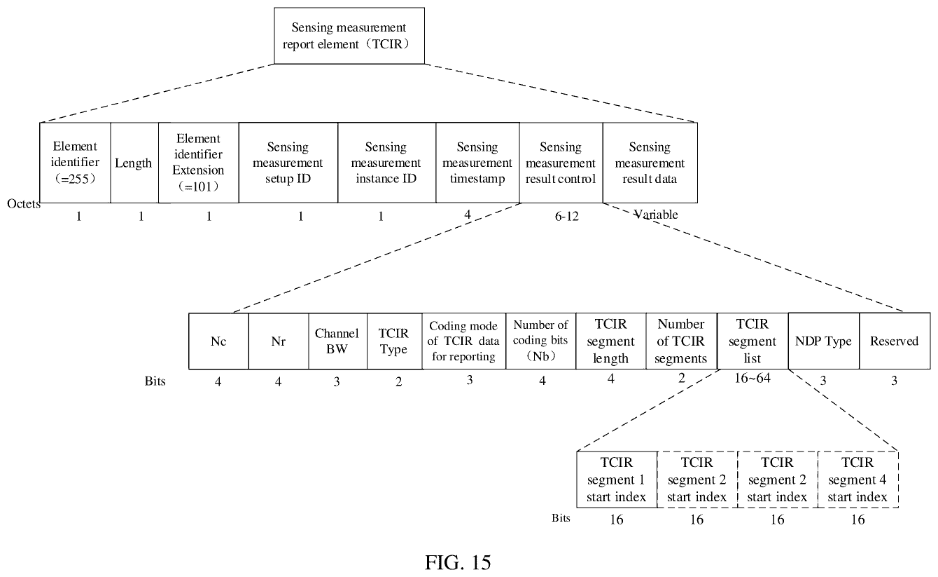

FIG. 17 is a schematic block diagram of a communication device 1700 according to an embodiment of the present disclosure. The communication device 1700 may include: a communication unit 1710, configured to transmit and/or receive a frame carrying sensing measurement reporting dependent information.

In a possible implementation, a frame carrying the sensing measurement reporting dependent information may be a sensing measurement reporting triggering frame.

In a possible implementation, the sensing measurement reporting dependent information is carried in a field for indicating trigger frame type dependent common information and/or a field for indicating trigger frame type dependent user information.

In a possible implementation, the trigger frame type dependent common information is used to indicate information applied to each user in a user information list.

In a possible implementation, the field carrying the trigger frame type dependent common information includes at least one of:
a field for indicating a sensing trigger frame subtype;
a field for indicating a sensing measurement setup identifier;
a field for indicating a sensing measurement instance identifier; or
a reserved field.

In a possible implementation, a value of the field for indicating the sensing trigger frame subtype being a first value indicates that the frame is the sensing measurement reporting trigger frame.

In a possible implementation, a value of the field for indicating the sensing measurement instance identifier increments by 1 from 0 to 255, and starts for re-incrementation from 0 again after 255 is reached.

In a possible implementation, a length of the field for indicating the trigger frame type dependent common information is a positive integer multiple of 8 bits.

In a possible implementation, the field for indicating the trigger frame type dependent common information is a field in an extremely high throughput (EHT) variant common information field of the sensing measurement reporting trigger frame.

In a possible implementation, the sensing measurement reporting trigger frame is used to trigger uplink EHT trigger frame based (Trigger Based, TB) physical layer protocol unit (PPDU) transmission.

In a possible implementation, the field for indicating the trigger frame type dependent user information is a field in an EHT variant user information field of the sensing measurement reporting trigger frame.

In a possible implementation, the trigger frame type dependent user information is used to indicate information applied to a first station (STA), and the first STA is a STA indicated by an identification field in the EHT variant user information field where the field for indicating the trigger frame type dependent user information is located.

In a possible implementation, the field for indicating the trigger frame type dependent user information includes a field for indicating whether to report an aggregation measurement result.

In a possible implementation, a value of the field for indicating whether to report the aggregation measurement result being a second value indicates that the first STA is allowed to report multiple measurement results from different measurement instances simultaneously in a sensing measurement reporting frame triggered by the sensing measurement reporting trigger frame; or, a value of the field for indicating whether to report the aggregation measurement result being a third value indicates that the first STA is not allowed to report multiple measurement results from different measurement instances simultaneously in a sensing measurement reporting frame triggered by the sensing measurement reporting trigger frame.

In a possible implementation, the field for indicating the trigger frame type dependent common information is a field in a HE variant common information field of the sensing measurement reporting trigger frame.

In a possible implementation, the sensing measurement reporting trigger frame is used to trigger uplink high efficiency (HE) TB PPDU transmission.

In a possible implementation, the field for indicating the trigger frame type dependent user information is a field in an HE variant user information field of the sensing measurement reporting trigger frame.

In a possible implementation, the trigger frame type dependent user information is used to indicate information applied to a second STA, and the second STA is a STA indicated by an identification field in the HE variant user information field where the field for indicating the trigger frame type dependent user information is located.

In a possible implementation, the field for indicating the trigger frame type dependent user information includes a field for indicating whether to report an aggregation measurement result.

In a possible implementation, a value of the field for indicating whether to report the aggregation measurement result being a fourth value indicates that the second STA is allowed to report multiple measurement results from different measurement instances simultaneously in a sensing measurement reporting frame triggered by the sensing measurement reporting trigger frame; or, a value of the field for indicating whether to report the aggregation measurement result being a fifth value indicates that the second STA is not allowed to report multiple measurement results from different measurement instances simultaneously in a sensing measurement reporting frame triggered by the sensing measurement reporting trigger frame.

In a possible implementation, a frame carrying the sensing measurement reporting dependent information may be a sensing measurement reporting frame.

In a possible implementation, the sensing measurement reporting dependent information includes at least one of channel state information (CSI) type of sensing measurement result data, truncated channel impulse response (TCIR) type of sensing measurement result data, or extended type of sensing measurement result data.

In a possible implementation, the CSI type of sensing measurement result data is carried in a CSI type of sensing measurement report element of the sensing measurement reporting frame; or, the TCIR type of sensing measurement result data is carried in a TCIR type of sensing measurement report element of the sensing measurement reporting frame; or, the sensing measurement result data in the extended type is carried in an extended type of sensing measurement report element of the sensing measurement reporting frame.

In a possible implementation, the CSI type of sensing measurement report element or the TCIR type of sensing measurement report element includes at least one of.
a field for indicating an element identifier;
a field for indicating a length;
a field for indicating element identifier extension;
a field for indicating a sensing measurement setup identifier;
a field for indicating a sensing measurement instance identifier;
a field for indicating a sensing measurement timestamp;
a field for indicating sensing measurement result control; or
a field for indicating sensing measurement result data.

In a possible implementation, a value of the field for indicating the element identifier extension being a sixth value indicates the CSI type of sensing measurement report element; or a value of the field for indicating the element identifier extension being a seventh value indicates the TCIR type of sensing measurement report element.

In a possible implementation, the field for indicating the sensing measurement result control in the CSI type of sensing measurement report element includes at least one of.
a field for indicating a number of columns of a CSI matrix;
a field for indicating a number of rows of a CSI matrix;
a field for indicating a channel bandwidth;
a field for indicating partial bandwidth information;
a field for indicating a coding mode of CSI data for reporting;
a field indicating a number of coding bits;
a field for indicating a grouping factor;
a field for indicating a measurement frame (NDP) type; or
a reserved field.

In a possible implementation, the field for indicating the sensing measurement result control in the TCIR type of sensing measurement report element includes at least one of.
a field for indicating a number of columns of a TCIR matrix;
a field for indicating a number of rows of a TCIR matrix;
a field for indicating a channel bandwidth;
a field for indicating a TCIR type;
a field for indicating a coding mode of TCIR data for reporting;
a field indicating a number of coding bits;
a field for indicating a length of a TCIR segment;
a field for indicating a number of TCIR segments;
a field for indicating a TCIR segment list;
a field for indicating an NDP type; or
a reserved field.

In a possible implementation, the extended type of sensing measurement report element includes at least one of.
a field for indicating an element identifier;
a field for indicating a length;
a field for indicating element identifier extension;
a field for indicating a sensing measurement setup identifier;
a field for indicating a sensing measurement instance identifier;
a field for indicating an NDP type;
a field for indicating HE-SIG-A/U-SIG information; or
a field for indicating a carrier frequency offset (CFO).

In a possible implementation, a value of the field for indicating the element identifier extension being an eighth value indicates the extended type of sensing measurement report element.

In a possible implementation, at least one of the CSI type of sensing measurement report element, the TCIR type of sensing measurement report element, or the extended-type of sensing measurement report element is carried in a field of the sensing measurement reporting frame for indicating a sensing measurement report list; and the field for indicating the sensing measurement report list is carried in a field of the sensing measurement reporting frame for indicating an action domain.

In a possible implementation, the field for indicating the action domain further includes at least one of.
a field for indicating an action type;
a field for indicating a common action subtype; or
a field for indicating a sensing subtype.

In a possible implementation, a value of the field for indicating the action type being an eighth value indicates that the sensing measurement reporting frame belongs to a common action frame; or, a value of the field for indicating the common action subtype being a ninth value indicates that the sensing measurement reporting frame belongs to a sensing action frame; or, a value of the field for indicating the sensing subtype being a tenth value indicates a sensing measurement reporting frame.

In a possible implementation, the field for indicating the action domain further includes at least one of.
a field for indicating an action type; or
a field for indicating a sensing action subtype.

In a possible implementation, a value of the field for indicating the action type being an eleventh value indicates that the sensing measurement reporting frame belongs to a newly defined sensing action frame; or, a value of the field for indicating the sensing action subtype being a twelfth value indicates a sensing measurement reporting frame.

In a possible implementation, a coding mode of CSI data or a coding mode of TCIR data includes at least one of low-complexity direct coding, low-complexity differential coding, or phase coding.

In a possible implementation, the low-complexity direct coding includes at least one of following steps:
calculating a scaling factor;
linearly scaling a real part and an imaginary part of an element in a matrix according to the scaling factor, and quantizing scaled real part and imaginary part into multiple intervals; or
performing direct coding on quantized data.

In a possible implementation, the low-complexity differential coding includes at least one of following steps:
calculating a scaling factor;
linearly scaling a real part and an imaginary part of an element in a matrix according to the scaling factor, and quantizing scaled real part and imaginary part into multiple intervals; or
performing differential coding on quantized data.

The communication device 1700 in the embodiments of the present disclosure can realize the corresponding functions of the communication device in embodiments of the aforementioned method 800. The corresponding processes, functions, implementations and beneficial effects of each module (a sub-module, a unit or a component, etc.) in the communication device 1700 can refer to the corresponding description in the above method embodiments, which will not be repeated herein. It should be noted that the functions described in the various modules (a sub-module, a unit or a component, etc.) in the communication device 1600 of the embodiments of the present disclosure can be implemented by different modules (a sub-module, a unit or a component, etc.) or by the same module (a sub-module, a unit or a component, etc.).

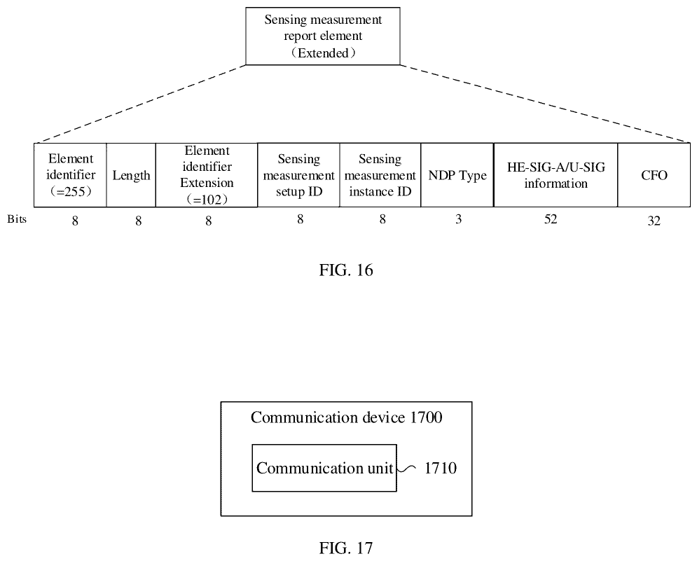

FIG. 18 is a schematic structural diagram of a communication device 1800 according to the embodiments of the present disclosure. The communication device 1800 includes a processor 1810. The processor 1810 can call and run a computer program from the memory, so as to enable the communication device 1800 to implement the methods in the embodiments of the present disclosure.

In another possible implementation, the communication device 1800 further includes a memory 1820. The processor 1810 can call and run a computer program from the memory 1820, so as to enable the communication device 1800 to implement the methods in the embodiments of the present disclosure.

The memory 1820 may be a separate device independent of the processor 1810, or may be integrated into the processor 1810.

In another possible implementation, the communication device 1800 may further include a transceiver 1830. The processor 1810 can control the transceiver 1830 to communicate with other devices, specifically, to transmit information or data to other devices or to receive information or data transmitted by other devices.

The transceiver 1830 may include a transmitter and a receiver. The transceiver 1830 may further include an antenna, where one or more antennas can be provided.

In another possible implementation, the communication device 1800 can be a communication device of the embodiments of the present disclosure, and the communication device 1800 can implement the corresponding processes implemented by the communication device in various methods 800 of the embodiments of the present disclosure, which will not be repeated herein for brevity.

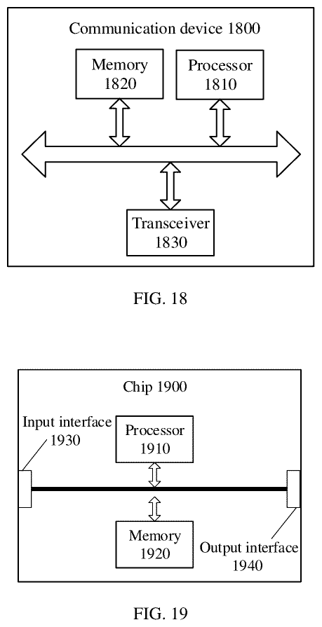

FIG. 19 is a schematic structural diagram of a chip 1900 according to the embodiments of the present disclosure. The chip 1900 includes a processor 1910. The processor 1910 can call and run a computer program from a memory to perform the methods in the embodiments of the present disclosure.

In another possible implementation, the chip 1900 further includes a memory 1920. The processor 1910 can call and run a computer program from the memory 1920, so as to implement the methods performed by the communication device 1700 in the embodiments of the present disclosure.

The memory 1920 may be a separate device independent of the processor 1910, or may be integrated into the processor 1910.

In another possible implementation, the chip 1900 further includes a communication interface 1930. The processor 1910 can control the input interface 1930 to communicate with other devices or chips, specifically, to acquire information or data transmitted by other devices or chips.

In another possible implementation, the chip 1900 further includes an output interface 1940. The processor 1910 can control the output interface 1940 to communicate with other devices or chips, specifically, to output information or data to other devices or chips.

In another possible implementation, the chip may be applied to the communication device 1700 in the embodiments of the present disclosure, and the chip can implement the corresponding processes implemented by the communication device 1700 in the various methods of the embodiments of the present disclosure, which may not be repeated herein for sake of brevity.

It should be understood that the chips mentioned in the embodiments of the present disclosure can also be called system-level chip, system chip, chip system or system-on-chip chip.

The processor mentioned above can be a general-purpose processor, a digital signal processor (digital signal processor, DSP), a field programmable gate array (field programmable gate array, FPGA), an application specific integrated circuit (application specific integrated circuit, ASIC) or other programmable logic devices, transistor logic devices, discrete hardware components, etc. The above-mentioned general processor may be a microprocessor or any conventional processor.

The memory mentioned above may be a volatile memory or a non-volatile memory, or may include both volatile and non-volatile memories. The non-volatile memory may be a read-only memory (read-only memory, ROM), a programmable read-only memory (programmable ROM, PROM), an erasable programmable read-only memory (erasable PROM, EPROM), or an electrically erasable programmable read-only memory (electrically EPROM, EEPROM) or a flash memory. Volatile memory may be random access memory (random access memory, RAM).

It should be understood that the above-mentioned memory is an exemplary but not restrictive description. For example, the memory in the embodiments of the present disclosure can also be static random access memory (static RAM, SRAM), dynamic random access memory (dynamic RAM, DRAM), synchronous dynamic random access memory (synchronous DRAM, SDRAM), double data rate synchronous dynamic random access memory (double data rate SDRAM, DDR SDRAM), enhanced synchronous dynamic random access memory (enhanced SDRAM, ESDRAM), synch link dynamic random access memory (synch link DRAM, SLDRAM), direct rambus random access memory (Direct Rambus RAM, DR RAM) etc. That is, memories in embodiments of the present disclosure are intended to include, but are not limited to, these and any other suitable types of memories.

The above embodiments may be implemented in whole or in part through software, hardware, firmware, or any combination thereof. When the above embodiments are implemented by using a software, the software may be implemented in a form of a computer program product in whole or in part. The computer program product includes one or more computer instructions. When the computer instructions are loaded and executed on a computer, all or some of the processes or functions of the implementations of the present disclosure are performed. The computer may be a general-purpose computer, a special-purpose computer, a computer network, or any other programmable apparatus. The computer instructions can be stored in a non-transitory computer-readable storage medium, or transmitted from one non-transitory computer-readable storage medium to another non-transitory computer-readable storage medium. For example, the computer instructions can be transmitted from one website, computer, server, or data center to another website, computer, server, or data center in a wired manner or in a wireless manner. Examples of the wired manner can be a coaxial cable, an optical fiber, a digital subscriber line (Digital Subscriber Line, DSL), or the like. The wireless manner can be, for example, infrared, wireless, microwave, or the like. The non-transitory computer-readable storage medium can be any computer accessible usable-medium or a data storage device such as a server, a data center, or the like which is integrated with one or more usable media. The usable medium can be a magnetic medium (such as a soft disc, a hard disc, or a magnetic tape), an optical medium (such as a digital video disc (DVD)), or a semiconductor medium (such as a solid state disk (Solid State Disk, SSD)).

It should be understood that in each embodiment of the present disclosure, the sequence numbers of the above-mentioned processes do not mean the order of execution, and the order of execution of each process should be determined by its functions and internal logic, and should not constitute any limitation on the implementing process of the embodiment of the present disclosure.

It should be understood that various embodiments in the present disclosure and features in various embodiments can be combined with each other without conflict.

Those skilled in the art can clearly understand that for the convenience and brevity of the description, specific working processes of a system, an apparatus and a unit described above can refer to the corresponding processes in the foregoing method embodiments, and details are not described herein again.

The foregoing descriptions are merely specific implementations of the preset application, but the protection scope of the preset application is not limited thereto; Any person skilled in the art could readily conceive of changes or replacements within the technical scope of the preset application, which shall all be included in the protection scope of the preset application. Therefore, the protection scope of the present disclosure shall be subject to the protection scope of the claims.

What is claimed is:

1. A communication method, comprising:
transmitting and/or receiving, by a communication device, a frame carrying sensing measurement reporting dependent information.

2. The method according to claim 1, wherein the frame comprises a sensing measurement reporting trigger frame.

3. The method according to claim 2, wherein the sensing measurement reporting dependent information is carried in a field for indicating trigger frame type dependent common information and/or a field for indicating trigger frame type dependent user information.

4. The method according to claim 3, wherein the trigger frame type dependent common information is used to indicate information applied to each user in a user information list.

5. The method according to claim 3, wherein the field carrying the trigger frame type dependent common information comprises at least one of:
a field for indicating a sensing trigger frame subtype;
a field for indicating a sensing measurement setup identifier;
a field for indicating a sensing measurement instance identifier; or
a reserved field.

6. The method according to claim 3, wherein the field for indicating the trigger frame type dependent common information is a field in an extremely high throughput (EHT) variant common information field of the sensing measurement reporting trigger frame.

7. The method according to claim 3, wherein the sensing measurement reporting trigger frame is used to trigger uplink EHT trigger frame based (TB) physical layer protocol unit (PPDU) transmission.

8. The method according to claim 3, wherein the field for indicating the trigger frame type dependent common information is a field in an HE variant common information field of the sensing measurement reporting trigger frame.

9. The method according to claim 3, wherein the sensing measurement reporting trigger frame is used to trigger uplink high efficiency (HE) TB PPDU transmission.

10. A communication device, comprising: a processor and a memory, wherein the memory is configured to store a computer program and the processor is configured to call and run the computer program stored in the memory, so as to enable a terminal device to perform:
transmitting and/or receiving a frame carrying sensing measurement reporting dependent information.

11. The communication device according to claim 10, wherein the frame comprises a sensing measurement reporting trigger frame.

12. The communication device according to claim 11, wherein the sensing measurement reporting dependent information is carried in a field for indicating trigger frame type dependent common information and/or a field for indicating trigger frame type dependent user information.

13. The communication device according to claim 12, wherein the trigger frame type dependent common information is used to indicate information applied to each user in a user information list.

14. The communication device according to claim 12, wherein the field carrying the trigger frame type dependent common information comprises at least one of:
a field for indicating a sensing trigger frame subtype;
a field for indicating a sensing measurement setup identifier;
a field for indicating a sensing measurement instance identifier; or
a reserved field.

15. The communication device according to claim 12, wherein the field for indicating the trigger frame type dependent common information is a field in an extremely high throughput (EHT) variant common information field of the sensing measurement reporting trigger frame.

16. The communication device according to claim 12, wherein the sensing measurement reporting trigger frame is used to trigger uplink EHT trigger frame based (TB) physical layer protocol unit (PPDU) transmission.

17. The communication device according to claim 12, wherein the field for indicating the trigger frame type dependent common information is a field in a HE variant common information field of the sensing measurement reporting trigger frame.

18. The communication device according to claim 12, wherein the sensing measurement reporting trigger frame is used to trigger uplink high efficiency (HE) TB PPDU transmission.

19. A non-transitory computer-readable storage medium having stored a computer program, wherein the computer program, upon being ran on a device, causes the device to perform:
transmitting and/or receiving a frame carrying sensing measurement reporting dependent information.

20. The non-transitory computer-readable storage medium according to claim 19, wherein the frame comprises a sensing measurement reporting trigger frame.
